(19) United States
(12) Patent Application Publication
(10) Pub. No.: US 2022/0138866 A1
(43) Pub. Date: May 5, 2022

(54) Systems and Methods for Managing Social Networks Based Upon Predetermined Objectives

(71) Applicants: Daniel Bouganim, Agoura Hills, CA (US); Andrew Wilson, Pasadena, CA (US)

(72) Inventors: Daniel Bouganim, Agoura Hills, CA (US); Andrew Wilson, Pasadena, CA (US)

(73) Assignee: Relationship Capital Technologies Inc., Pasadena, CA (US)

(21) Appl. No.: 17/086,801

(22) Filed: Nov. 2, 2020

(51) Int. Cl. G06Q 50/00; G06Q 30/00; G06Q 10/10

(52) U.S. Cl. CPC G06Q 50/01; G06Q 10/107; G06Q 30/01

(57) ABSTRACT

In many embodiments, a relationship management system includes a relationship management server system that identifies an objective with respect to an entity defined by a customer relationship management (CRM) service, identifies a first set of contacts associated with the objective, aggregates event information associated with the first set of contacts, scores the objective based upon event information associated with the first set of contacts to generate at least one engagement score, and provides recommendation data to the CRM service from which a task is created within the CRM service associated with at least one contact in the first set of contacts based upon the at least one engagement score.

### CROSS-REFERENCE TO RELATED APPLICATIONS

This current application is a continuation of U.S. patent application Ser. No. 14/804,100, filed Jul. 20 2015, entitled “Systems and Methods for Managing Social Networks Based Upon Predetermined Objectives” to Bouganim et al., which claims the benefit of U.S. Provisional Patent Application No. 62/026,637 filed on Jul. 19, 2014, the disclosures of which are hereby incorporated by reference in their entirety.

### FIELD OF THE INVENTION

The present invention relates generally to online social networks and more specifically to methods for managing social networks based upon predetermined objectives.

### BACKGROUND

Social networks provide valuable relationships, particularly in a professional context where a social network may be leveraged for a business referral, a personal introduction, and/or the purchase of goods or services. Historically, the size of an individual's social network was constrained by the individual's ability to meet people and the effort required to maintain traditional on-going communications (e.g. in person meetings, telephone calls, mail). The advent of the social web has radically expanded the number of potential relationships an individual can maintain, while ubiquitous online communication has created a breadth of low effort communication channels (e.g. short message feeds, email, instant messaging).

### SUMMARY OF THE INVENTION

Relationship management systems in accordance with embodiments of the invention are configured to provide systematic ways for a user to measure, and manage relationships in the user's social network. Relationship management systems can analyze a user's social network and provide recommendations concerning actions the user can take to strengthen relevant relationships and achieve defined objectives.

In many embodiments, a relationship management system includes a relationship management server system that includes a processor and memory containing software and a database that includes several contacts obtained from at least one source of contact information. In many embodiments, the software directs the processor in the relationship management server system to identify an objective with respect to an entity defined by a customer relationship management (CRM) service, identify a first set of contacts within the plurality of contacts associated with the objective, aggregate event information associated with the first set of contacts from at least one source of event information, score the objective based upon event information associated with the first set of contacts to generate at least one engagement score, and provide recommendation data to the CRM service from which a task is created within the CRM service associated with at least one contact in the first set of contacts based upon the at least one engagement score.

In a further embodiment, the software directs the processor in the relationship management server system to identify additional contacts that are stored within the CRM service that are not in the several contacts stored in the database and update the several contacts to include the additional contacts.

In a further embodiment again, at least one source of contact information is selected from the group consisting of a CRM service, a web mail service, an enterprise mail system, and an online social network.

In yet a further embodiment, the software directs the processor in the relationship management server system to aggregate event information from at least one source of event information selected from the group consisting of a CRM service, a web mail service, an enterprise mail system, a web calendaring service, an enterprise calendaring system, call data records, and an online social network.

In yet a further embodiment again, the software directs the processor in the relationship management server system to score at least one relationship between contacts in the first set of contacts based upon the aggregated event information to create a scored relationship graph.

In still another embodiment, the at least one stored objective relates to a specific project entity within a database maintained by a CRM service.

In still another embodiment again, the at least one stored objective relates to the scored relationship graph.

In a further embodiment still, the software directs the processor in the relationship management system to recommend at least one new contact for inclusion in the first set of contacts based on aggregated event information.

In another further embodiment still, the software directs the processor in the relationship management server system to provide data regarding the relationship scores between a user and a contact to the CRM service for display within a user interface (UI) generated by the CRM service.

In the software directs the processor in the relationship management system to aggregate event information based on metadata obtained from the at least one source of event information, wherein the metadata includes information selected from the group consisting of entities related to an event, a type of event, a duration of the event, and an intimacy level of the event.

In a still further embodiment again, the event information includes information regarding offline interactions between users and contacts comprising phone calls, transactions, collaborative projects, and in-person meetings.

In another additional embodiment, the event information includes information regarding online communications between users and contacts comprising electronic communications.

In a still further embodiment again, a relationship score provides an indication of a strength of a relationship between a user and a contact.

In a yet further embodiment, the software directs the processor in the relationship management system to analyze the scored relationship graph to identify at least one contact for inclusion in the first set of contacts based on a relationship score of the contact, and associate the identified at least one contact with the objective.

In still another embodiment, the software directs the processor in the relationship management system to analyze the scored relationship graph to identify at least one contact with a relationship score below a threshold value and generate a recommendation with respect to the identified contact in order to increase the relationship score.

In a further embodiment still again, the at least one engagement score provides an indication of progress of a group of users relative to an objective.

In yet an additional further embodiment, an entity is selected from the group consisting of a customer entity, an account entity, and an opportunity entity.

In a further embodiment again, an objective is defined by associating contacts with the objective.

In another embodiment again, the software directs the processor in the relationship management system to provide prioritized recommendations concerning the most important actions to take to achieve an objective.

In still another embodiment again, the software directs the processor in the relationship management system to generate a call sheet that includes at least one recommendation concerning an action relevant to achieving the objective.

In a further embodiment again, the software directs the processor in the relationship management system to generate a user interface that identifies a first subset of actions for completion within a first time period and a second subset of actions for completion within a second time period, wherein the second time frame is longer than the first time frame.

In yet a further embodiment still, the software directs the processor in the relationship management system to automatically capture real-time event information from at least one source of event information, and provide the real-time event information to the CRM system for display within a user interface (UI) generated by the CRM service.

### BRIEF DESCRIPTION OF DRAWINGS

FIG. 1 is a conceptual illustration of a relationship management system in accordance with an embodiment of the invention.

FIG. 2 is a network diagram illustrating a relationship management system in accordance with an embodiment of the invention.

FIG. 2A is a network diagram illustrating a relationship management system implemented in combination with a CRM system in accordance with an embodiment of the invention.

FIG. 3 is a software diagram illustrating components of a relationship management system in accordance with an embodiment of the invention.

FIG. 4 is a flow chart illustrating a process for generating a scored social graph in accordance with an embodiment of the invention.

FIG. 5 conceptually illustrates a user interface for characterizing a relationship with a contact in a relationship management system in accordance with an embodiment of the invention.

FIG. 6 conceptually illustrates a user interface for importing event information from various data sources in accordance with an embodiment of the invention.

FIG. 7 conceptually illustrates a user interface for characterizing multiple relationships in accordance with an embodiment of the invention.

FIG. 8 conceptually illustrates the prioritization of contacts in a relationship management system in accordance with an embodiment of the invention.

FIG. 9A conceptually illustrates groups of contacts formed within a relationship management system in accordance with an embodiment of the invention.

FIG. 9B conceptually illustrates a user interface for creating a new group of contacts in accordance with an embodiment of the invention.

FIG. 9C conceptually illustrates a user interface for creating a new group of contacts related to a project in accordance with an embodiment of the invention.

FIG. 10 conceptually illustrates factors influencing a relationship score calculated in accordance with an embodiment of the invention.

FIG. 11 conceptually illustrates the different levels of resistance individual contacts may have to building a relationship.

FIG. 12 is a graph conceptually illustrating the impact of different events over time on a relationship score calculated in accordance with an embodiment of the invention.

FIG. 13A conceptually illustrates a user interface including a call list generated by a relationship management system in accordance with an embodiment of the invention.

FIG. 13B conceptually illustrates a user interface including a prioritized list of recommended user actions with respect to contacts generated by a relationship management system in accordance with an embodiment of the invention.

FIG. 14 conceptually illustrates the integration of relationship scores into the user interface of an online social network in accordance with an embodiment of the invention.

FIG. 15 conceptually illustrates the collection of relationship information via the user interface of an online social network integrated with a relationship management system in accordance with an embodiment of the invention.

FIG. 16 conceptually illustrates a process for communicating with a CRM system for generating task lists in accordance with an embodiment of the invention.

FIG. 17 illustrates an example of a user interfaces of a CRM system that incorporates data obtained from a relationship management system in accordance with many embodiments of the invention.

FIG. 18 illustrates an example of a user interfaces of a CRM system that incorporates data obtained from a relationship management system in accordance with many embodiments of the invention.

### DETAILED DESCRIPTION

Turning now to the drawings, relationship management systems and methods for managing a social network in accordance with embodiments of the invention are disclosed. Building and maintaining relationships is an extremely important activity, but relationships and the success of relationship building activities are difficult to measure. Relationship management systems in accordance with many embodiments of the invention construct a social graph corresponding to a user's social network and score each of the user's relationships (i.e. the links in the social graph) based upon the aggregation and evaluation of information describing events, which may include interactions (e.g., phone calls, emails) or activities (e.g., attending events, in-person meetings), that impact the ongoing strength of the relationship. The scoring of a relationship can involve assigning a single or multiple scores to the relationship. As is discussed further below, the social graph and the scores generated by the relationship management system can capture relationships between a user and a variety of different types of entity including (but not limited to) a contact, a group of contacts, an organization, an opportunity, a deal, and/or a transaction.

In many embodiments, a user can set targets for specific relationships and/or define immediate or overarching objectives. The objectives that can be defined within a relationship management system are largely dependent upon the requirements of specific applications and can include objectives with respect to a defined entity within a database maintained by a Customer Relationship Management (CRM) system such as (but not limited to) a customer entity (e.g., a company), an account entity (e.g., a customer account), or an opportunity entity (e.g., a new business venture). In many embodiments, objectives are defined by associating contacts with the objective. Based upon the specified targets and/or objectives, the relationship management system can provide prioritized recommendations concerning the most important actions the user can take to achieve specific relationship targets and/or objectives. In many embodiments, the process of generating recommended contacts with whom to interact and/or recommended actions with respect to specific contacts involves considering factors including (but not limited to) the impact of the action on a specified relationship objective, and/or a specified goal.

In a number of embodiments, the relationship management system maintains one or more engagement scores that provide an indication of progress towards achieving a particular objective or goal of the user and/or a group of users. Relationship scores and/or engagement scores may also be calculated for contacts and/or groups of contacts as related to an objective. The relationship scores may provide an indication of the strength of a relationship between users and contacts while the engagement scores may provide an indication of the progress of the user(s) towards achieving an objective, and thus the engagement scores may be computed based in part on the relationship scores of the users with groups of contacts related to the objective. Furthermore, the engagement scores may provide transparency regarding the activities (i.e., events/interactions) of users relative to an objective, which may be particularly useful for conducting various types of analysis, including (but not limited to) forecasting, and/or activity monitoring.

In many embodiments, the relationship management system enables a user to define a group of users and/or contacts relevant to a specific objective and provides engagement scores (i.e., benchmarks) regarding the progress of the users toward achieving a desired objective. For example, a team of sales personnel within a company (group of users) may be assigned to a particular objective (e.g., obtaining a new company as a customer) and the level of events (e.g., interactions and meetings) occurring between this group of users relative to the potential new customer may be scored to provide an indication of the effectiveness of the sales activities towards achieving the objective. The relationship management system may thus enable transparency and access to detailed information regarding the activities of users directed towards a particular objective, and/or relationship information, including strength values of the relationship statuses of the users with the contacts related to the objective, among various other types of information that may be useful for forecasting sales activities and/or to conduct analysis in making business decisions.

By enabling the scoring of relationships and/or progress towards achieving objectives, the relationship management system can provide a systematic, customized way for a user to effectively prioritize effort in the management of relationships within a social network. In many embodiments, the relationship management system generates a list of recommended contacts with which the user should take action and/or a list of actions based upon the user's priorities and/or the user's objectives. In a number of embodiments, the list is further prioritized by factors including (but not limited to) the urgency of the actions. In certain embodiments, urgency is evaluated based upon: the relative priority of the objectives; relative deadlines; desired close dates; and/or elapsed time since last interaction. In several embodiments, the recommended actins are provided to a CRM system to create task entities that are presented to the user (e.g., a task list user interface).

In several embodiments, the relationship management system generates a call sheet (a prioritized list of recommended actions) that provides recommendations concerning actions that are most relevant to achieving one or more objectives and/or that have the greatest urgency. In various embodiments, the user interface identifies a first subset of actions as having high priority for completion within a short time frame and additional actions for completion during a longer time period. As can readily be appreciated, the continuous gathering of metadata concerning events by a relationship management system enables the relationship management system to continuously and dynamically update contact recommendations and/or action recommendations in real time and in response to actions taken by the user (or the contact). Relationship management systems can also provide recommendations concerning various aspects of the user's social network based upon data mining that compares the user's social network to the social networks of other users who may have similar occupations or are pursuing similar goals. In many embodiments, relationship management systems use machine learning and statistical techniques to infer information from user networks and observed behaviors that can be used to enhance the ability of other users to achieve their objectives. In many embodiments, relationship management systems are configured to provide recommendations concerning best practices for achieving a specific outcome with respect to a specific contact. In several embodiments, the relationship management system indexes correspondence and other communications with specific contacts and/or other data related to a contact to identify topics relevant to a specific contact so that outreach can be both targeted and relevant to that contact. In certain embodiments, the relationship management system can identify contacts and/or other entities having relationship and/or engagement scores that are sufficiently high to initiate a specific action. In the context of a CRM system, the relationship management system could identify entities within the CRM that are ready to be advanced to a next deal stage within the CRM. In a number of embodiments, the relationship management system is configured to monitor entities within a CRM having renewal deadlines and uses user relationship scores with contacts associated with the renewing entities to add tasks to the CRM system related to increasing relationship scores with contacts at the renewing entities in advance of the renewal deadline. In other embodiments, indexed information can also be used to perform searches relating contacts to specific objectives or to specific groups.

In several embodiments, the relationship management system is implemented as a scoring engine that enables the scoring of event or interaction information collected by third party systems such as a Customer Relationship Management (CRM) system. When a relationship management system is implemented as an extension of a CRM system in this way, the relationship management system can provide a valuable tool for building a relationship up to a point where a contact becomes a prospective customer (where they are associated with a specific opportunity entity within the CRM's database) and lends itself to process tracking typically provided by CRM systems. Once in the opportunity stage in the CRM, the relationship management system can use its same scoring capability to provide critical engagement analytics to ensure the user (or group of users relevant to an objective) is systematically investing in each contact (or group of contacts relevant to the objective) to move the opportunity forward. In many embodiments, an overall objective may be specified according to a set of smaller sub-stages helpful to achieving the overall objective, and the engagement scores may provide an indication of the progress of the user's activities relative to each sub-stage of the objective. This type of activity benchmarking may help in the analysis and forecasting of user activities toward an objective. Furthermore, different groups of users may be associated with different sub-stages of an overall objective and thus the relationship management system may be used to analyze each sub-stage and provide activity benchmark scores of progress toward the overall objective. This allows for the benchmarking of objectives based upon deal stage, which may provide better transparency into the user activities relative to an objective. For example, a first set of users may have an objective of bringing new leads related to potential new customers and a second set of users may have an objective of closing deals with the new leads. However, if the first set of users are increasingly bringing in new leads without an overall increase in sales, then management would be able to see a potential problem area stage (e.g. the deal closers) within the overall deal stages. For example, management may determine there is a lack of activity between the second set of users and the new contacts. The relationship management system may be used to provide the second set of users with call sheets of contacts that they should be talking to in order to progress toward an objective.

In many embodiments, the relationship management system is a separate system that pulls information concerning entities and/or activities from a CRM system. In this way, the relationship management system can obtain information indicating contacts that are relevant to an objective indicated by a defined entity within the CRM database(s). The relationship management system can then push relationship scores and/or engagement scores to the CRM system for presentation via the user interface of the CRM system. The relationship management system may also push event information into the CRM system captured by the relationship management system. In particular, the relationship management system may capture real-time event information from many different sources of event information and provide this information to the CRM system.

In several embodiments, the relationship management system can push data concerning recommended actions to the CRM system which can use the data to generate task entities associated with a user of the CRM that are displayed via the CRM's user interface in the form of a task list or any other appropriate user interface mechanism.

In many embodiments, the relationship management system is integrated with online social networks and relationship scores generated by the relationship management system can be provided to the online social network for display with respect to relationships within the online social network. Relationship management systems, methods of building scored social graphs, and the use of scored social graphs to provide users with recommended actions relevant to defined goals in accordance with embodiments of the invention are discussed further below.

### Relationship Management System Architectures

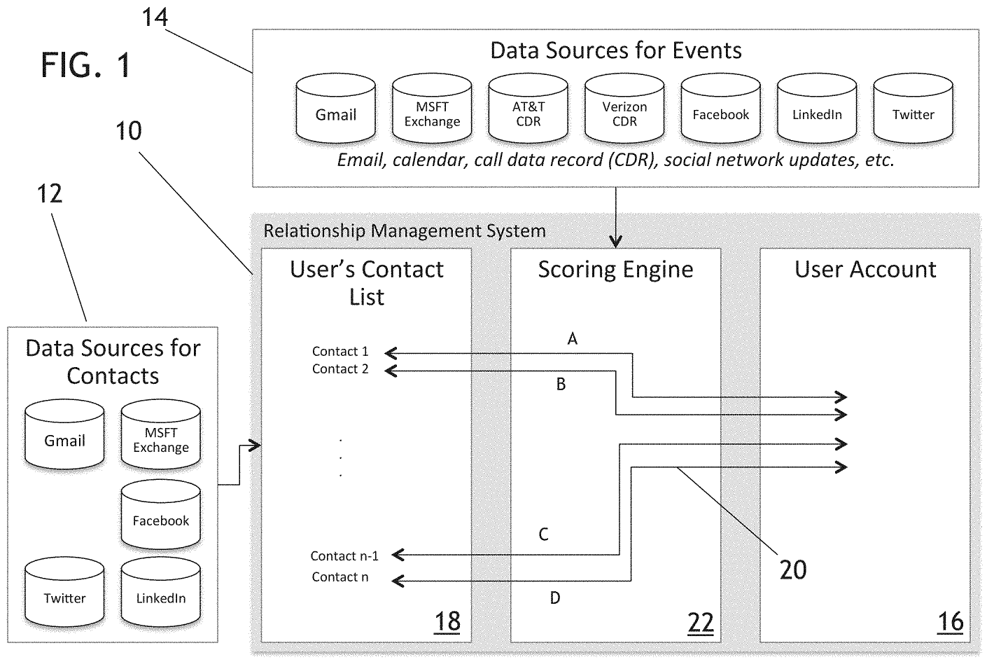

A variety of architectures can be utilized to implement a relationship management system in accordance with embodiments of the invention. A relationship management system in accordance with an embodiment of the invention is conceptually illustrated in FIG. 1. The relationship management system 10 is configured to connect with one or more sources of contact information 12 and one or more sources of event information 14, including interactions (both online and offline) and/or meetings between the user and their contacts. When a user creates a user account 16, the relationship management system 10 uses information provided by the user to retrieve contact information from the sources of contact information 12. The relationship management system uses the retrieved information to construct a contact list 18 and/or provide recommendations concerning contacts with whom the user should interact and/or recommended actions with respect to the contacts. In some embodiments, the user may specify an objective with respect to a customer entity (e.g., company), an account entity (e.g., a company account), and/or an opportunity entity (e.g., a business venture) and the relationship management system may retrieve a group of recommended contacts associated with the customer, account, opportunity and/or objective using information available from various different public and private sources. In particular, public information about a company may be obtained from a plurality of sources, including government databases (e.g., SEC filings), company websites, among various other sources of information.

Account information provided by the user can also be used to access sources of event information 14 and to aggregate information concerning events involving the user and one or more of the user's contacts. Based upon the aggregated contact list and the aggregated event information, the relationship management system can create a scored social graph 20 that can be utilized in the management of relationships within the user's social network.

As described above, relationships may be scored between a user and a contact. When dealing with contacts associated with a specific objective, the relationship scoring may generate engagement scores with respect to that opportunity. Thus a user's scored social graph may include relationship scores quantifying the strength of/or engagement scores quantifying progress towards an objective. The term social network is typically used to describe relationships that exist in the real world, whereas, the term social graph is used to describe relationships that exist online. In the social graph 20 built using the user's contact list, the links in the social graph represent relationships between the user and the user's contacts 18. The relationships may be relationships that are purely based upon online interactions, but typically also include relationships involving offline interactions such as, but not limited to, phone calls, transactions, collaborative projects, and in person meetings. In several embodiments, the relationship management system attempts to aggregate as much online contact information for a user from as many sources as possible in order to try and build a consolidated social graph 20 that is coextensive with the user's social network.

In addition to building a social graph, a scoring engine 22 within the relationship management system is configured to assign one or more scores to each relationship or link in the user's social graph based upon aggregated information concerning events (e.g., interactions and/or in-person meetings) that involve the user and one or more members of the user's contact list (i.e. members of the user's social graph). In many embodiments, the relationship management system 10 automatically gathers metadata concerning events from sources of event information 14. Through the collection of metadata, a relationship management system can do more than simply count events but also estimate event quality. The collected metadata describes the events, therefore, the metadata can be used by a scoring engine to score the significance of discrete events of the same type, based upon their real world importance. In several embodiments, the scoring engine utilizes metadata indicative of the type of event, the duration of the event, and the intimacy of the event in scoring the event. In other embodiments, the variety of metadata is utilized in the scoring of events is only limited by the range of metadata available to the relationship management system.

The scoring engine can also consider any of a variety of additional factors in assigning one or more scores to events and/or in determining the impact an event has upon an overall relationship including but not limited to the status or significance of the contact with whom the event is related.

In addition to the automated gathering of event information, many relationship management systems in accordance with embodiments of the invention solicit user input with respect to specific events including subjective information concerning the importance and/or outcome of the event. In this way, the user can adjust the significance placed upon events by the scoring engine to increase the likelihood that the scored social graph generated by the relationship management system closely corresponds with the relationships that the user enjoys within the user's real world social network.

In several embodiments, relationship events, which may include various types of interactions both online and offline and/or meetings between a user and a contact, are scored using event metadata that is automatically collected by the relationship management system from various sources of event information. Scores based upon metadata can be further enhanced using subjective or qualitative information provided by the user, sometimes in response to prompting by the relationship management system. In many embodiments, the relationship management system recommends specific relationship event scores where additional subjective tuning will provide the most information and/or be most useful to the accuracy of the relationship management system. In a number of embodiments, the user is prompted for additional subjective tuning when an event occurs that significantly impacts the scoring of the relationship (a “high value event”). The term tuning is used here to refer to the modification of one or more automatically generated scores by the user to more accurately describe the event/information that is the subject of the score.

The tuning may also allow the user to adjust the score of a relationship when an automatically generated score may not reflect how the user subjectively perceives the strength of a relationship. For example, if a user has an extremely successful telephone conversation with a potential new customer, the user may, at the outset, specify a high relationship score for the relationship, even though the score that may have been generated by the relationship management system may likely be lower, especially given the minimal amount of prior event history between the new customer and the user. Likewise, if a detrimental event occurs to a long lasting relationship, the user may adjust or fine tune the relationship score to reflect this occurrence. In many embodiments, the relationship management system may be used across many users (e.g., by management), and provide managers with administrative level access to tune the scored relationships held by different users with respect to contacts. For example, a user may engage another colleague to assist during a particular stage of a deal, and the colleague may fine tune the relationship scores based on their own subjective perceptions of the strengths of various relationships with contacts. In this way, the relationship management system can employ user feedback, from a user, other users, and or managers with administrative level access in order to increase the likelihood that the user's scored social graph closely corresponds to the relationships the user enjoys in the real world. This same feedback mechanism can assist with machine learning and enhance the accuracy of the core scoring engine.

Sources of contact information that can be aggregated by a relationship management system include but are not limited to remotely hosted web mail services, such as the Gmail service provided by Google, Inc. of Mountain View, Calif., contacts maintained by an enterprise mail server, such as a Microsoft Exchange server distributed by Microsoft Corporation of Redmond, Wash. or an equivalent server, and/or contact information maintained by an online social network such as the Facebook service provided by Facebook, Inc. of Palo Alto, Calif., the Twitter service provided by Twitter, Inc. of San Francisco, Calif. and/or the LinkedIn service provided by LinkedIn, Inc. of Mountain View, Calif. In a number of embodiments, information can be exported from these services in a file including but not limited to a comma separated variable file. In several embodiments, contact information is directly retrieved via an application programming interface (API). In many embodiments, the relationship management system relies upon another system, including but not limited to a CRM, to partially or completely aggregate contact information. When contact information is aggregated by a separate system, the aggregated event information can be passed to the scoring engine via an API. In several embodiments, the relationship management system is integrated with other systems and provides information including but not limited to relationship scores via an API for use by the other systems. Although specific sources of contact information are listed above, any of a variety of different sources of contact information can be interfaced with a relationship management system to enable aggregation of contact information in accordance with embodiments of the invention as appropriate to a specific user and/or application.

Sources of event information can include any of a variety of sources including email services, such as Gmail and/or a Microsoft Exchange server, call data records from mobile phones or other telephony systems, meeting and calendars, and/or social network messages, updates, postings, and/or activities on services including, but not limited to, Facebook, LinkedIn, and Twitter. In a number of embodiments, event metadata can be exported in a batch file format from these sources and/or accessed via an API. In many embodiments, event metadata is obtained from mobile devices including but not limited to smart phones configured to communicate with a relationship management system via an application installed on the mobile device. In several embodiments, the relationship management system relies upon another system, including but not limited to a CRM, to partially or completely aggregate event information. When event information is aggregated by a separate system, the aggregated event information can be passed to the scoring engine via an API. Although specific sources of event information are listed above, any of a variety of sources of event information can be interfaced with a relationship management system in accordance with embodiments of the invention to enable the aggregation of event information as appropriate to a specific user and/or application.

### Implementing Relationship Management Systems

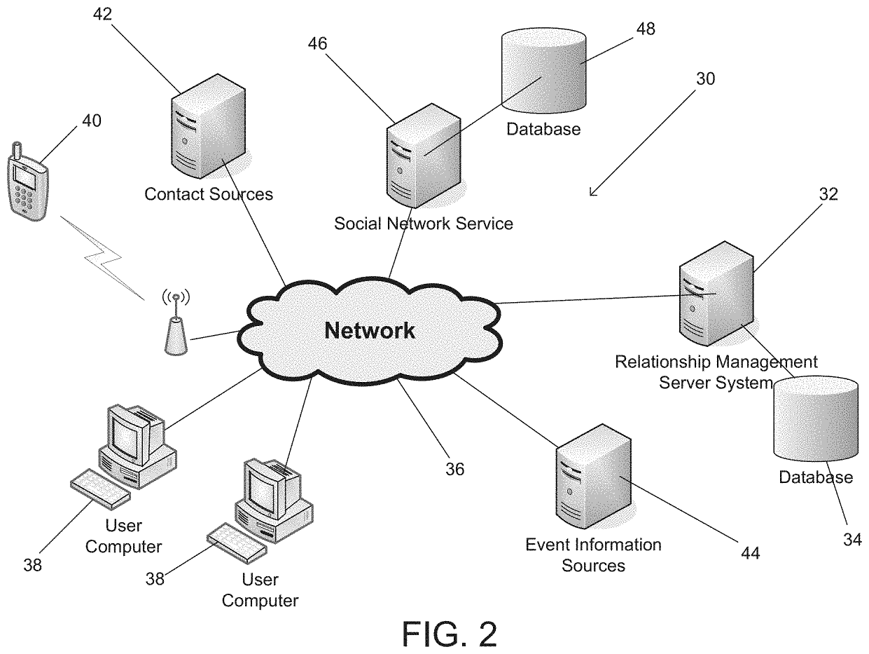

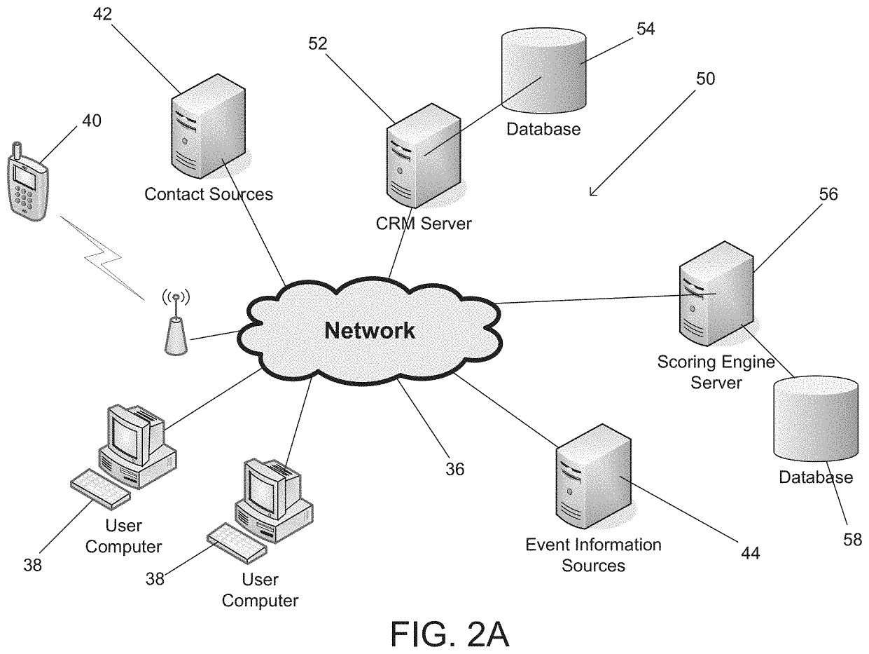

A variety of system architectures can be utilized to implement relationship management systems in accordance with embodiments of the invention including (but not limited to) web services architectures. A relationship management system in accordance with an embodiment of the invention is illustrated in FIG. 2. The relationship management system 30 includes a relationship management server system 32 that is configured to build and score social graphs in the manner outlined above. The information collected by the relationship management server system 32 is stored in a database 34.

Users can communicate with the relationship management server system via a network 36 using one of a plurality of different classes of user device including but not limited to computers 38 and mobile phones 40. The relationship management server system 32 can also collect information concerning a user's contacts and events involving the contacts from one or more contact sources 42 and event information sources 44. In some embodiments, relationship management server system 32 can collect information concerning contacts relevant to a particular objective with respect to a customer entity, an account entity, or an opportunity entity. As described above, a customer entity may include an organization (e.g., a company) and the relationship management server system may collect information regarding contacts affiliated with the company. The contacts may be employees and/or executives of the company, investors, shareholders, directors, among various other types of personnel that may be affiliated with a company. The collected information may be from publicly available sources of information, including, for example, company public filings obtained from government databases (e.g., Securities and Exchange Commission “SEC” filings), company profiles available on the internet, among various other sources of information.

The collected information is utilized by the relationship management system to construct one or more scored social graphs with respect to each user and the user's contacts. As is discussed further below, the relationship management system can also analyze the scored social graph. In many embodiments, the relationship management server system is configured to provide recommendations with respect to interacting with specific contacts based upon objectives defined by the user and/or the relative urgency of achieving specific objectives. In several embodiments, the relationship management server system is configured to index metadata collected concerning contacts and events and provides the ability to search for people relevant to a specific topic or objective. In other embodiments, the analysis performed by the relationship management server system is only limited by the requirements of a specific application and the capabilities of the server system.

In many embodiments, the relationship management system is integrated with one or more services enabling the services to retrieve information for the relationship management system. For example, the LinkedIn service provided by LinkedIn, Inc. can be integrated with a relationship management system to retrieve relationship scores for display on a user profile within the LinkedIn service. In other embodiments, any of a variety of services can be integrated with a relationship management system in accordance with embodiments of the invention.

### Extending CRMs to Include Relationship Management

Relationship management systems can be implemented as separate systems that aggregate contact and event information. In many embodiments, the relationship management system is implemented as an extension to a CRM system. When a relationship management system extends a CRM system, the relationship management system typically relies upon the CRM system to aggregate contact information and/or event information (e.g., deal or sales transactions). The relationship management system may simply provide an API via which the CRM system can pass and receive aggregated information and event history to a scoring engine. In several embodiments, the scoring engine may also receive information from other sources. The scoring engine can then return one or more scores for an individual relationship and/or a scored social graph or an engagement score with respect to a specific objective with respect to a customer entity, an account entity, and/or an opportunity entity being tracked in the CRM system.

A relationship management system configured to extend a CRM system in accordance with an embodiment of the invention is illustrated in FIG. 2A. The relationship management system 50 includes a CRM server 52 and an associated database 54 connected to a network 36. The CRM server communicates with user computing devices 38 and user mobile devices 40 via the network 36. The CRM server 52 can obtain contact information directly from user devices and/or indirectly from other sources of contact information 42 including but not limited to the sources of contact information discussed above with respect to FIG. 1. The CRM server 52 can also obtain event information directly from user devices and/or indirectly from other sources of event information 44 including but not limited to the sources of event information discussed above with respect to FIG. 1. In the illustrated embodiment, a scoring engine server 56 and associated database 58 are also connected to the network 36. The CRM server 52 can provide a stream of event information to the scoring engine server 56 in order to obtain relationship scores. In a number of embodiments, the CRM server can provide a stream of event information related to a specific relationship and the scoring engine server evaluates the event information and scores the relationship. In several embodiments, the CRM server provides a stream of contact information and event information related to the contacts. The scoring engine can use the contact information and event information to build a scored social graph. The scored social graph can then be provided back to the CRM server in its entirety. Alternatively, the scoring engine can utilize the scored social graph to provide specific relationship scores and/or engagement scores to the CRM server, and/or recommendations relevant to specified user objectives through a series of intelligent recommendations. Scoring of relationships and generation of recommendations in accordance with embodiments of the invention are discussed further below.

### Relationship Management System Software Architecture

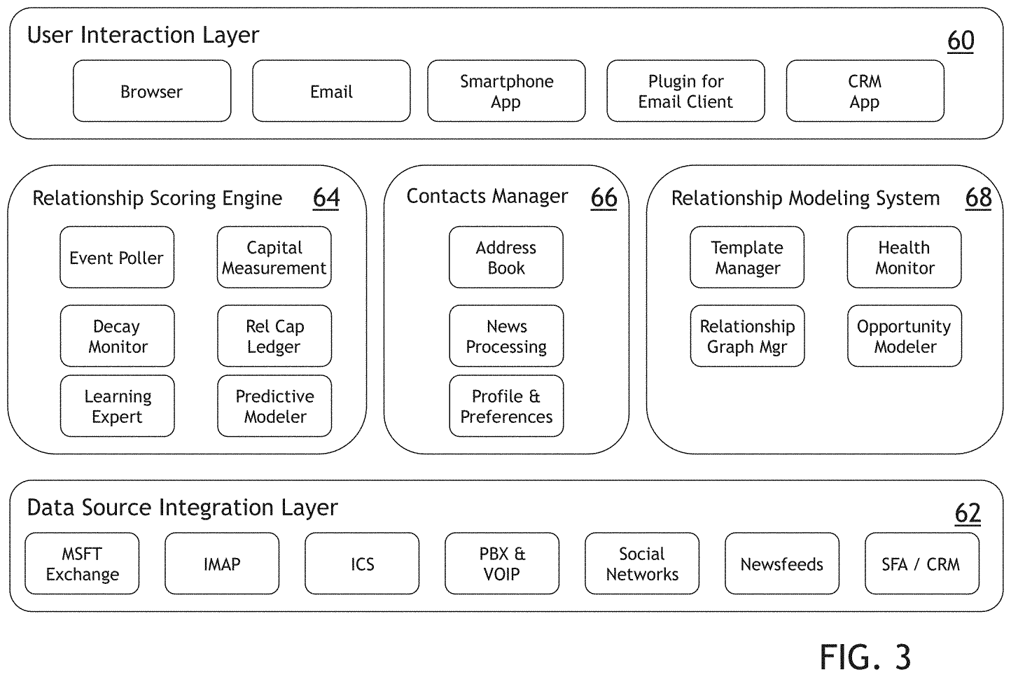

Relationship management systems in accordance with embodiments of the invention can be implemented using a variety of software architectures appropriate to a specific application. A relationship management system software architecture in accordance with an embodiment of the invention is illustrated in FIG. 3. In the illustrated embodiment, the relationship management system software includes various modules including a user interaction layer 60, a data source integration layer 62, a relationship scoring engine 64, a contacts manager 66, and a relationship modeling system 68. In many embodiments, the contact manager 66 manages the data from the contacts integrated by the relationship management system, and the relationship scoring engine 64 scores event information with respect to specific contacts. The scored events can then be provided to the relationship modeling system, which constructs a scored social graph using the scored event information and the characteristics of the relationships between the user and specific contacts. In some embodiments, the modeling system can also deliver engagement scores between the user and specific contacts associated with an objective or opportunity. The engagement score may provide an indication regarding the progress level of user(s) activity(ies) relative to a desired objective. In particular, the engagement score may provide a progress indication of the level and effectiveness of events between groups of users and contacts with respect to a particular objective that may be helpful in conducting forecasting and analytics. For example, management may use the engagement scores to forecast sales activity and/or analyze the user activities with respect to an objective. Although a specific software architecture is illustrated in FIG. 3, any of a variety of architectures appropriate to a specific application can be implemented in accordance with embodiments of the invention.

### Scoring Relationships

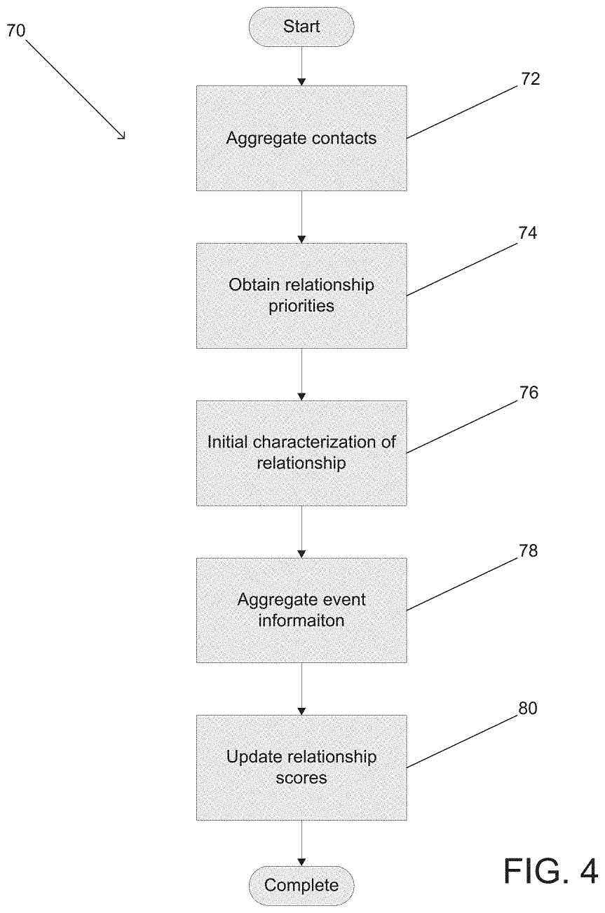

A variety of processes can be utilized in constructing and scoring a social graph in accordance with embodiments of the invention. A process for constructing and scoring a social graph in accordance with one embodiment of the invention is illustrated in FIG. 4. The process 70 involves aggregating (72) contact information to define the relationships that form the user's social graph. In many embodiments, information concerning relationship priorities is also obtained (74). In several embodiments, the information is obtained directly from the user. In a number of embodiments, recommended relationship priorities are generated based upon a user profile. The manner in which relationships can be prioritized is discussed further below.

The process 70 illustrated in FIG. 4 also involves characterizing (76) the initial characteristics of some or all of the relationships enjoyed by the user. In many embodiments, the initial characterization involves describing the type and importance of the relationship and assigning one or more initial scores to the relationship. The user can directly assign importance and desired relationship target scores to a relationship. Alternatively, a relationship management system can automatically assign importance and/or relationship target scores to relationships based upon aggregated information and/or information provided by the user and the user can modify the automatically assigned scores. In many embodiments, a relationship management system recommends relationships that will provide the most value to the relationship management system (e.g. the relationships most relevant to specific objectives identified by a user) and specifically requests that the user characterize the identified relationships. In the cases where a relationship management system is integrated with a CRM, the contacts, objectives and targets can be imputed and automatically associated with either objectives or target relationship levels. The combination of the relationship definitions and initial relationship scores constitute a scored social graph that can then be updated over time based upon events involving the user and the user's contacts.

Once one or more initial relationship scores have been assigned, the process 70 aggregates (78) event information and updates (80) the relationship scores applied to the user's social graph. In many embodiments, a relationship management system modifies relationship scores based upon the elapse of time (relationships tend to weaken over time), and aggregated event information (relationships can be strengthened or diminished based upon the occurrence of different events).

Although a specific process for constructing and updating a user's social graph in response to events involving the user and the user's contacts is illustrated in FIG. 4, any of a variety of processes can be used to construct a scored social graph in accordance with embodiments of the invention. Systems and methods of acquiring contact information, obtaining relationship priorities, initially characterizing relationships, aggregating event information, and updating relationship scores in accordance with embodiments of the invention are discussed further below.

### Aggregating Contact Information and Characterizing Relationships

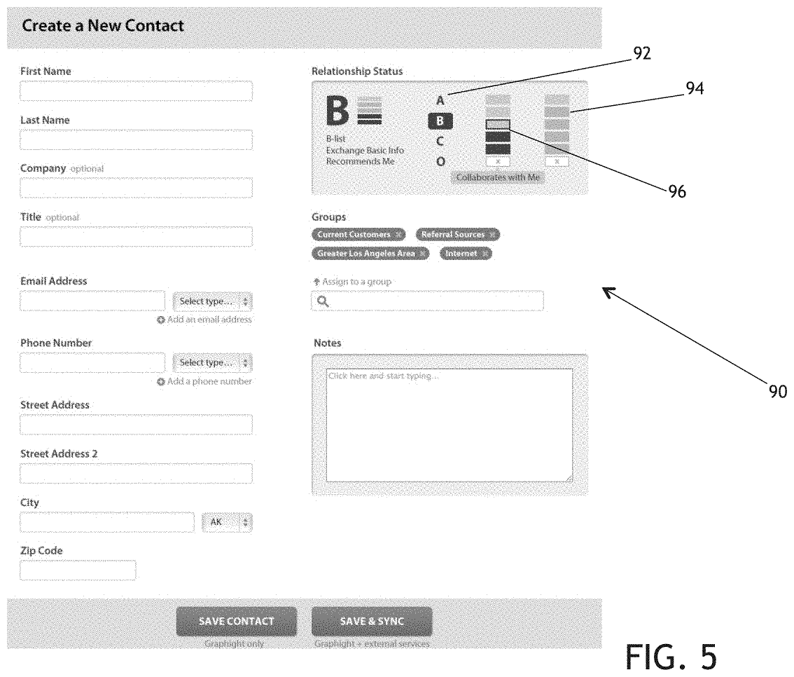

Many systems including but not limited to CRM systems and online social networks support the capability of aggregating contact information. In a number of embodiments, a relationship management system can provide a user interface that enables a user to manually enter contact information and define the relationship that exists between the user and the contact. A user interface configured to enable the entry of information concerning a contact and to obtain an initial characterization of the relationship a user enjoys with the contact in accordance with an embodiment of the invention is illustrated in FIG. 5. The user interface 90 provides the ability for a user to characterize the importance of a relationship. In the illustrated embodiment, the user interface enables the user to select between a number of levels 92 representing different levels of importance. The levels are shown as the user's “A-list”, “B-list”, “C-list” and “Other”. In other embodiments, any number and variety of groups can be utilized to indicate the importance of a contact through inheritance from its associated groups including inferring association from third party systems like CRM. The user interface 90 also provides mechanisms that can be utilized to score the relationship and to attach a contact to one or more objectives. In the illustrated embodiment, the user can manually over-ride the score of the relationship by setting a level 94 from six different levels. A similar set of levels 96 is provided so that the user can manually specify an objective or target relationship score. The characterization of relationships is discussed further below.

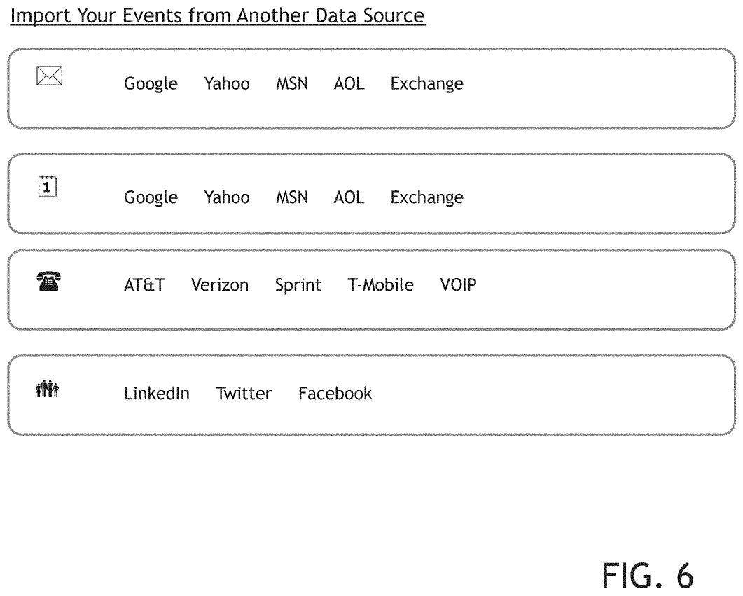

In the user interface illustrated in FIG. 5, a user interface is illustrated that enables a user to manually provide a description of a relationship with a single contact. In many embodiments, contact information aggregated by other applications and/or services can be imported into a relationship management system by a user and these settings can be inherited from that service to individual contacts. A user interface that provides a user with the opportunity to enable a relationship management system to access aggregated contact and event information on other services is illustrated in FIG. 6. In the illustrated embodiment, the user is provided with a selection of mail services, calendaring services, telephone and internet phone services, and online social networking services from which information can be obtained by the relationship management system. Although specific services are shown in FIG. 6, a relationship management system is only limited in the services from which it can obtain contact and/or event information by the services themselves. Furthermore, the user interface of a relationship management system in accordance with embodiments of the invention can involve the presentation of a sequence of screens that can guide a user through the process of granting the relationship management system access to different services.

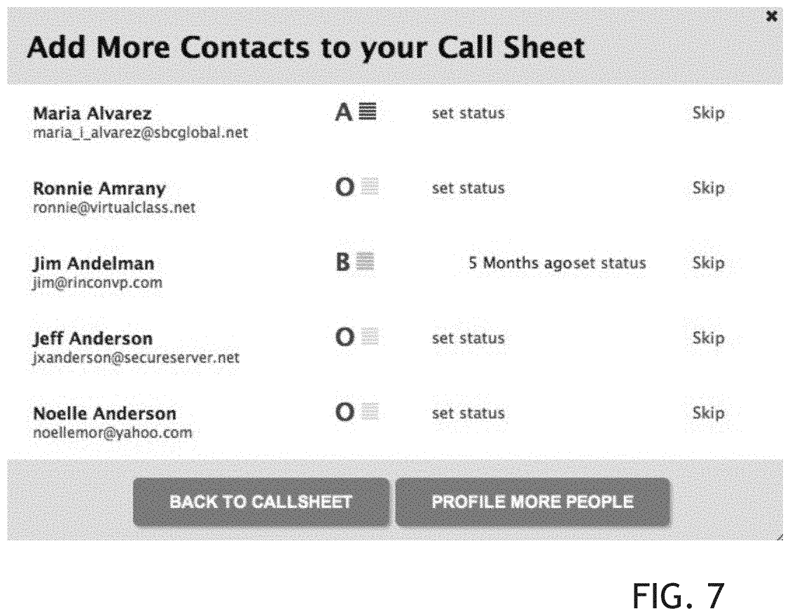

When a batch of aggregated contact information is imported into a relationship management system, a user will typically be presented with a user interface enabling the user to provide an initial characterization of the relationship the user enjoys with each imported contact. A user interface enabling the rapid characterization of multiple relationships in accordance with embodiments of the invention is illustrated in FIG. 7. In the illustrated embodiment, the user interface enables a user to set the importance, and current status of the relationship the user enjoys with each of the listed contacts. The user can also individually define a target relationship status with respect to each contact or assign to a group whereby such targets would be inherited from the group target. In a number of embodiments, the list of contacts presented to the user is sorted using a smart sorting system that lists contacts in order based upon the level of interaction between the contact and the user and/or the importance of the contact to relationship objectives defined by the user. This sorted list allows the user to focus their effort on active contacts versus old dormant contacts. In many embodiments, the recommendation engine of the relationship management system will search contact meta-data (including related event data) and identify the most relevant contacts that will have the greatest influence on the user's ability to achieve the specific objective. In this way, the relationship management system can obtain the information that will be most influential on the recommendations provided by the recommendation engine without requiring the user to characterize the relationship of every contact in a user's contact list.

Although specific user interfaces are illustrated in FIGS. 5-7, any of a variety of user interfaces can be utilized in the aggregation of contact information and initial characterization of the relationships that a user enjoys with each contact in accordance with embodiments of the invention. The characterization of relationships and ongoing scoring of relationships are discussed further below.

### Describing a Contact/Relationship Type

The type of relationship that a user enjoys with a specific contact can often depend upon the nature of the contact. In order to accommodate variance in the importance of specific contacts and the ease with which relationships can be built and/or maintained with specific contacts (i.e resistance), many relationship management systems in accordance with embodiments of the invention attempt to obtain information describing the contact or the relationship type. The information collected by a relationship management system describing a user's contacts or relationship type is typically dependent upon the requirements of a specific application.

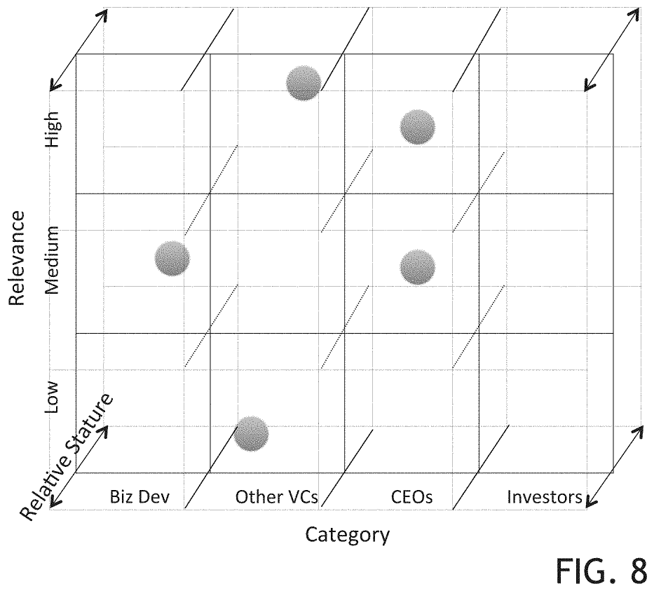

A multi-dimensional framework for describing a contact in accordance with an embodiment of the invention is conceptually illustrated in FIG. 8. In the illustrated embodiment, each contact is categorized based upon relevance of the contact to a user's desired objectives (e.g. professional and/or business). In addition, the contact is further categorized based upon the relative stature of the user and the contact (i.e. whether the contact is a peer, a superior, or a subordinate of the user). In other embodiments, any of a variety of factors can be utilized to categorize contacts including but not limited to the stature of the contact within a particular category. As is discussed further below, the description of a user's contacts can be utilized by the scoring engine of a relationship management system to evaluate the significance of specific events with regard to building and/or maintaining relationships with specific contacts. Although many relationship management systems capture information describing a user's contacts for the purpose of scoring the user's social graph, a number of relationship management systems in accordance with embodiments of the invention do not differentiate between different categories of contacts and treat all contacts in the same manner for the purpose of calculating relationship scores.

Although a user can manually describe contacts, services such as LinkedIn, Google News, Twitter, CrunchBase, Jigsaw.com, and Dun & Bradstreet can provide a significant amount of publicly available information describing a contact. In many embodiments, the scores assigned to describe a contact or relationship type are automatically generated based upon publicly available information concerning the contact. A similar approach of automatically applying third party data to profile and organize contacts can be derived from information stored in private CRM systems. Once the contact is described, the characterization of the relationship is completed by assigning one or more relationship scores to the relationship the user enjoys with the contact. The manner in which initial relationship scores can be assigned in accordance with embodiments of the invention is discussed further below.

### Assigning Initial Relationship Scores

The initial characterization of a relationship involves assigning one or more initial relationship scores to the relationship. In many embodiments, initial relationship scores are manually assigned by a user. In a number of embodiments, the initial relationship scores can be selected from a list such as, but not limited to, the following list:
1— Basic Contact
2—Knows My Name
3—Exchanges Basic Information with Me
4—Collaborates with Me
5—Recommends Me
6—Promotes Me

The above categories enable a user to translate real world understandings of the relationship between the user and the contact into one or more numerical scores that can be provided to a scoring engine. In many embodiments, the stages of the relationship are non-linear. In other embodiments, any of a variety of techniques can be used for defining possible relationship scores within a relationship management system including but not limited to scores selected from a continuum and/or different lists of quantized relationship characterizations. In several embodiments, the initial relationship scores and the ongoing relationship scores are quantified, however, the ongoing scores assigned to the relationship are determined on a continuum by the scoring engine. In many embodiments, the initial relationship scores are generated automatically based upon a historical analysis of aggregated event information.

### Characterizing Relationships Based Upon User Priorities

Relationship management systems in accordance with embodiments of the invention can be customized based upon the priorities of an individual user. In several embodiments, the relationship management system solicits information from a user concerning the relationships that the user prioritizes and/or goals (i.e., objectives) that the user desires to accomplish (e.g. raising money, generating new business, hiring a key employee, obtaining new office space). In several embodiments, the relationship management system enables the user to associate individual contacts with groups of contacts and likewise associate this group with one or more objectives and/or goals. For example a group of contacts may be associated with a particular company and also the objective of obtaining the particular company as a new customer. Based upon the user's priorities, the relationship management system can automate some of the scoring utilized in describing individual contacts. In addition, the relationship management system can provide relationship target recommendations based upon the user's priorities and/or a list of recommended activities with respect to specific contacts and/or groups of contacts related to achieving one or more specific objectives.

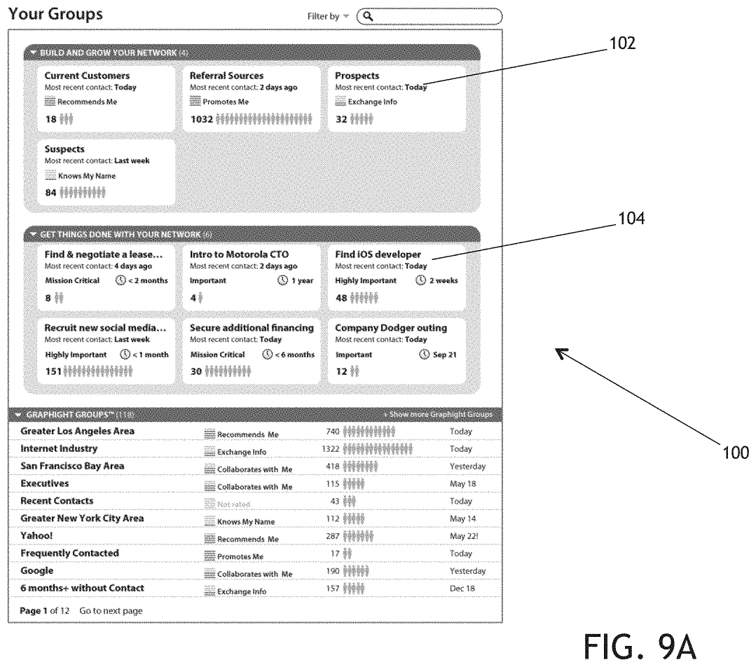

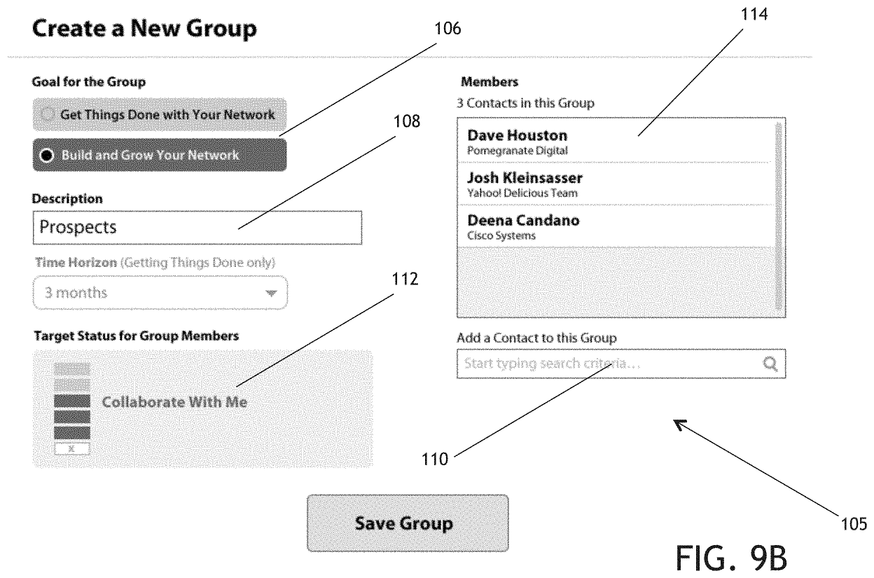

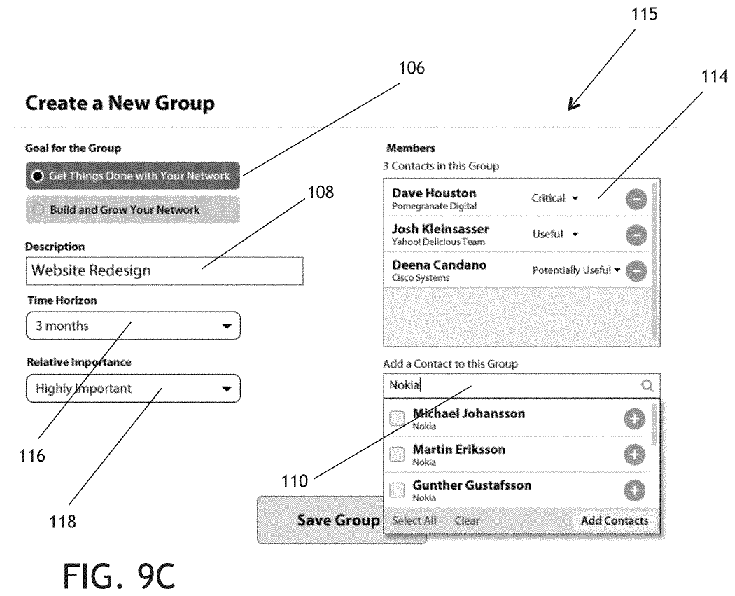

In a number of embodiments, a relationship management system enables a user to define groups of contacts with respect to specific objectives. The groups can be defined with respect to a general objective such as (but not limited to) building and growing a network, and/or a specific objective or task that leverages contacts within the user's network. A conceptual illustration of a user interface generated by a relationship management system illustrating different groups of contacts created by a user in accordance with embodiment of the invention is illustrated in FIG. 9A. The user interface 100 includes a number of groups 102 of contacts defined by a user that identify contacts that are important to objectives related to building and growing the user's network. In the illustrated embodiments, the groups are “Current Customers”, “Referral Sources”, “Prospects” and “Suspects”. In other embodiments, any of a variety of groups can be defined related to building and growing a user's network. The user interface 100 also includes a number of groups 104 of contacts defined by the user with respect to specific tasks where the basis of engagement with the contacts in the group is achieving a specific stated goal rather than merely developing the user's network (although engagement in this way typically strengthens relationships). In the illustrated embodiment, the groups of contacts include “Find iOS developer” and “Secure Additional Financing”.

User interfaces that can be used to create the different types of groups referred to above are conceptually illustrated in FIGS. 9B and 9C. A user interface 105 is shown in FIG. 9B that can be used to create a group of contacts for the purpose of building the user's relationship with the contacts. The user interface 105 includes a mechanism 106 for selecting that the purpose (e.g., objective) of the group is to grow the user's network. The user interface includes a text box 108 for naming the group, and a text box 110 for adding contacts to the group. The user interface 105 lists 114 the contacts that are members of the group and provides a mechanism 112 for defining a relationship objective or target for the members of the group. The user interface 115 shown in FIG. 9C is similar to the user interface 105 shown in FIG. 9B with the exception that the user interface 115 is used to create a group of contacts related to the completion of a task or project. When the mechanism 106 is used to select that the group is being created for the purpose of completing a project, the user interface 115 provides a mechanism 116 to specify the time horizon for the project and a mechanism 118 for specifying the importance of the project. As can readily be appreciated, the groups that can be defined are only limited by the requirements of a specific user.

Once groups are defined, the relationship management system can generate recommendations specific to the objectives of the group (whether relationship targets or project objectives) in addition to recommendations related to achieving target relationship scores. In addition, the recommendation engine can also suggest individuals that should be included in the group based upon searchable metadata or similarities with members of the group or information concerning the group's objective (identifying contacts relevant to specific topics is discussed further below). In many embodiments, the relationship management system enables the user to assign priorities to groups and/or specify time horizons for the objective underlying the group so that the recommendation engine can prioritize its recommendations accordingly. In other embodiments, any of a variety of information can be provided to characterize the importance of groups for the purpose of providing input to the recommendation engine of the relationship management system. If the relationship management system is connected to a CRM, then the groups can be auto-populated based on tagging or an opportunity status this is imported from the CRM thus avoiding re-characterizing the contact.

When a user provides information concerning the relationships that the user prioritizes either directly or by placing a contact within a group, the information can be utilized by the relationship management system to recommend actions that can be taken to advance the user's relationship priorities. In addition, the relationship management system can assign multiple scores to each relationship, where each score is indicative of the importance of the relationship to a specific objective. Once the user's priorities are known to the relationship management system, the relationship management system can identify relationships that are aligned with the user's priorities and assign recommendations to contacts accordingly. In addition to defining the importance, or a similar characteristic, of a contact, the relationship management system can also recommend target relationship scores for the relationship that the user enjoys with the contact. The manner in which the initial characterization of relationships and relationship score targets are utilized by relationship management systems in the ongoing scoring of a user's social graph and with the generation of recommendations are discussed further below.

### Updating Relationship Scores

A variety of models can be utilized to characterize a relationship for the purpose of scoring the relationship between a user and a contact in a relationship management system in accordance with embodiments of the invention. In general the strength of a relationship is impacted by events involving the user and the user's contact. Certain types of event foster relationships, such as communication. Other types of events can diminish a relationship. For example, in a professional context a request by the user for a referral can marginally diminish the relationship. Scoring engines in accordance with embodiments of the invention consider the effect of different types of events when scoring relationships. In addition, scoring engines can also model certain “natural” phenomena such as the tendency for relationships to naturally diminish over time. Although specific examples of relationship models are discussed below, the manner in which relationship management systems in accordance with embodiments of the invention can score relationships is only limited by the information concerning the relationship available to the relationship management system.

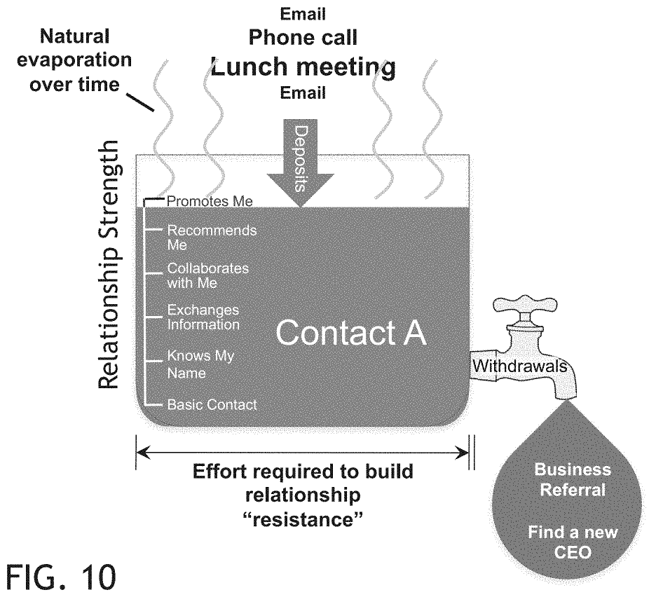

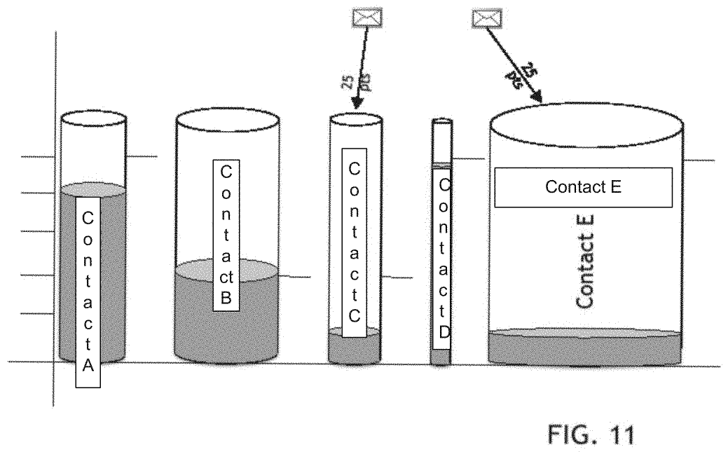

A conceptual illustration of a relationship model in accordance with an embodiment of the invention is shown in FIG. 10. In the illustrated embodiment, the analogy of a vessel full of liquid is used to model the relationship. The height of the liquid is indicative of the strength of the relationship. A variety of events can strengthen a relationship, including but not limited to a person meeting and/or the user providing a benefit to the contact, and these can be considered to add fluid to the vessel. As noted above, certain events can diminish a relationship, including but not limited to the user requesting a benefit from the contact, and these can be considered to be outflows of fluid from the vessel. In addition, the natural weakening of relationships over time is conceptually illustrated as evaporation. The effort required to build a relationship can vary based upon the individual with whom the user is trying to build a relationship. This variance can be described as the concept of resistance, which is represented by the diameter of the vessel in FIG. 10. That is, the extent to which there is resistance to developing a stronger relationship with a specific contact. Factors that can influence resistance include, but are not limited to, the relative stature of the contact, the relevance of the contact to the user, and the size of the contact's social network. In many embodiments, the relationship management system utilizes aggregated information and/or information provided by users to assign a relationship matching score indicative of alignment in such things including (but not limited to) values, interests, education, and/or hobbies. Once determined, the relationship matching score can be utilized in determining resistance and in identifying relationships that are likely to more rapidly advance a user's priorities or the propensity of that relationship to reach the highest levels. The varying resistance to building and maintaining relationships with different contacts is conceptually illustrated in FIG. 11. The area of the base of each vessel indicates the resistance of the corresponding contact.

Although scoring engines typically do not model relationships and aggregated event information as fluids, the model illustrated in FIGS. 10 and 11 is analogous to many of the models that can be utilized by scoring engines in accordance with embodiments of the invention. In many embodiments, the scoring engine of a relationship management system utilizes a scoring function as follows:

$${s}_{x , y , t} = f ( {s}_{x , y , 0} , {\sum }_{k = 0}^{t} {\sum }_{{j}_{k}} a ( s ( {e}_{{j}_{k}} ( k ) ) , {{e}_{j}}_{k} ( k ) , t - k ) )$$

where,
s_{x,y,t} is the relationship score for the relationship between the user x and contact y at time t, s_{x,y,t} can be a vector quantity,
eⱼ_{ₖ}(k) is the jₖth event to occur between time t=k−1 and time t=k,
the function s(.) scores the value of event eⱼ_{ₖ}, (k),
the function a(.) ages the score assigned to the event eⱼ_{ₖ}, (k) that occurred at time interval k based upon the score assigned to the event s(eⱼ_{ₖ}, (k)), the type of event eⱼ_{ₖ}, (k), and the time t−k that has elapsed since the event occurred, and
the function ƒ(.) is a function of the initially assigned relationship score s_{x,y,0}, the sum of the aged event scores for all events jₖ that occurred at every time interval from time k=0 to time k=t involving the user x and contact y.

In the model described above, each score assigned to an event is separately aged over time in a manner that is dependent upon the type of event and the amount of time that has elapsed. In many embodiments, computational complexity is reduced by utilizing a model that determines the current relationship scored based upon aging of the most recent relationship score(s) and the sum of the scores assigned to the events that occurred since the most recent relationship score(s) was calculated.

In other embodiments, a variety of relationship models are utilized that score relationships based on various factors that can include one or more of the factors illustrated in FIGS. 10 and 11 and/or one or more of the factors described above with respect to the function ƒ(.) above. Processes for assigning values to specific events when scoring relationships in accordance with embodiments of the invention are discussed further below.

### Scoring Events

The manner in which events are scored by a relationship management system in accordance with embodiments of the invention typically depends upon the event information aggregated by the relationship management system. In a number of embodiments, the relationship management system aggregates metadata describing events in addition to aggregating information concerning the mere occurrence of the events. The metadata available to the relationship management system can be utilized in any of a variety of ways to assign scores to individual events. In several embodiments, the scoring engine utilizes metadata indicative of the type of event, the duration of the event, and the intimacy of the event in scoring the event. In other embodiments, the variety of metadata is utilized in the scoring of events is only limited by the range of metadata available to the relationship management system.

In a number of embodiments, the weighted value of a specific event is determined by assigning predetermined values to various pieces of metadata associated with the event. In several embodiments, metadata weights are refined over time based upon observing the manual modifications users make to the relationship scores calculated by the scoring engine.

As is discussed further below, relationship management systems in accordance with embodiments of the invention can solicit qualitative feedback concerning events and relationship scores as a way of refining the overall effectiveness of the scoring engine. In a number of embodiments, the value assigned to a specific type of event is modified based upon a user supplied event outcome score, an event memorability/intimacy score, and/or an event outcome score. In several embodiments, information is only solicited to refine the score(s) assigned to high value events. In other embodiments, the event outcome score and the event intimacy score can be automatically determined by the relationship management system based upon aggregated metadata concerning the event. As is discussed further below, the event outcome score and event intimacy score can be manually entered and/or modified by the user. In many embodiments, various factors indicative of the outcome of an event can be expressed as an aggregated event quality score. In other embodiments, the value assigned to a specific event is calculated based upon the factors relevant to a specific application including but not limited to functions similar to those outlined above.

Factoring Subjective Information into Relationship Scores

In many embodiments, the relationship management system solicits subjective information concerning events from the user in order to improve the correspondence between the user's scored social graph and the user's social network. In several embodiments, the relationship management system utilizes aggregated information concerning events to send prompts to the user to provide additional subjective information concerning events to assist the scoring engine in assigning a value to the event. In addition, the system can periodically request that the user confirm relationship scores assigned to a contact to further verify the correspondence between the user's scored social graph and the user's social network. This user feedback can be used for machine learning and allow the scoring to get better over time. In a number of embodiments, an application on a smart phone and/or SMS messages are utilized to solicit subjective information from the user. In other embodiments, any of a variety of techniques can be utilized to solicit subjective information from the user. Once the subjective information has been obtained, the scoring engine can incorporate the additional information into the scoring process and assign one or more revised relationship scores accordingly. In addition, the scoring engine can periodically update various event metadata weightings utilized by the system to conform the scores assigned by the scoring engine to the user's experience.

### Recommendations Based Upon User Priorities

Relationship management systems in accordance with embodiments of the invention can be utilized to provide analysis and/or recommendations based upon a user's scored social graph and user defined priorities. As discussed above, relationship management systems can make simple recommendations based upon user defined priorities such as providing recommendations concerning the importance of specific contacts and the establishment of relationship targets with respect to specific contacts. The recommendations that can be provided by a relationship management system in accordance with embodiments of the invention are not, however, limited to these simple recommendations. In many embodiments, the relationship management system provides recommendations concerning activities with specific contacts that will maintain or elevate relationships to desired target levels. As noted above, the recommendations can also relate to activities that can advance specific objectives associated with a group of contacts.

### Defining Relationship Targets

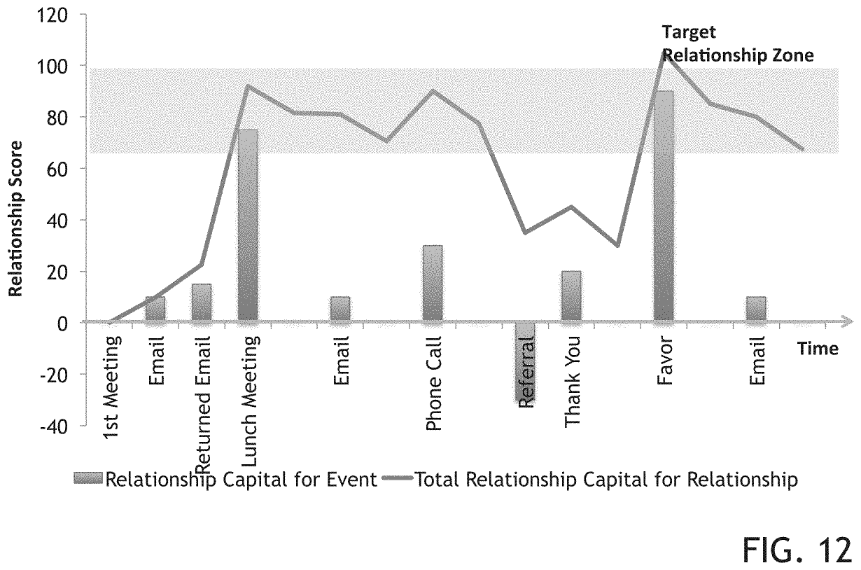

The relationship score(s) assigned to a relationship by the scoring engine of a relationship management system in accordance with embodiments of the invention will typically fluctuate over time based upon the occurrence of various events. The fluctuation of a relationship score over time in response to different events is illustrated in FIG. 12. Relationship targets can be defined for specific relationships either individually or based on their association with specific groups. In the illustrated embodiment, a relationship target zone is indicated and a relationship management system can compare the relationship score to the target relationship score zone and provide recommendations to a user concerning actions that can be taken to maintain the relationship in the target zone or elevate the relationship into the target zone. These recommendations can be further prioritized based upon the priorities defined by the user.

### Call Sheets

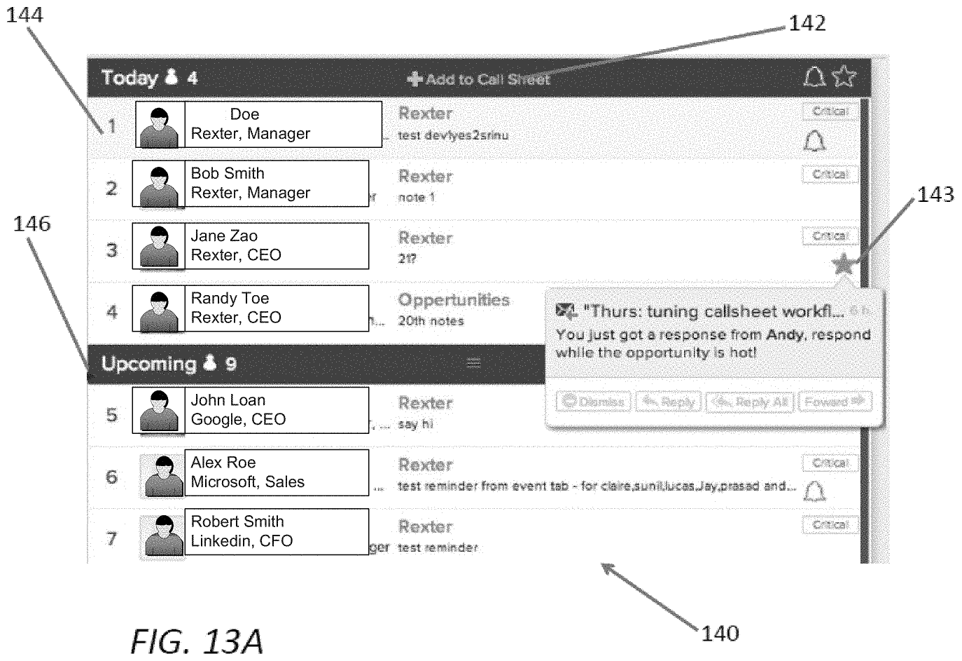

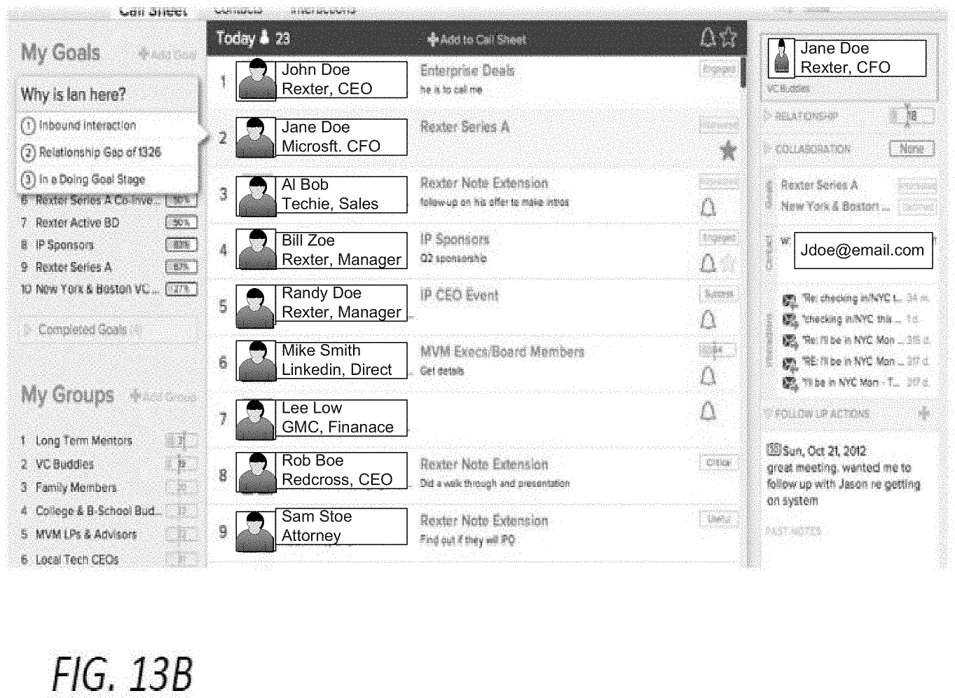

A set of prioritized actions that a relationship recommendation engine can generate may be referred to as a “call sheet”. A typical call sheet indicates the actions that can be taken with respect to specific contacts in order to obtain the greatest benefit in reaching specified targets for one or more relationship scores. In a number of embodiments, processes for generating call sheets or ranking actions with respect to specific contacts consider user specified objectives. A user interface generated by a relationship management system showing recommended actions based upon priorities specified by a user in accordance with an embodiment of the invention is illustrated in FIG. 13A. In the illustrated embodiment, the user is provided with recommendations concerning contacts with whom to communicate. In a number of embodiments, the presented recommendations are identified by sorting each recommendation generated by the recommendation engine based upon the relative importance assigned by the user to each of the project groups. A variety of business intelligence rules can be utilized to select the recommendations that are presented in the call sheet including but not limited to the recommendations that will have the greatest impact on achieving the relationship objectives specified by the user. In many embodiments, the user is provided with more detailed recommendations concerning specific types of events that the user should arrange with a specific contact in order to maintain or move the user's relationship with the contact into a target relationship zone. In several embodiments, the list is ordered based upon the activities that will achieve the greatest gains or optimal yield in achieving a user's overall priorities. In other embodiments, the list can be intelligently ordered based upon any of a number of factors including but not limited to the importance of the contact, the contact's resistance, the elapsed time since the last event, and the distance between a desired relationship status and the current status of the relationship with the contact. In a number of embodiments, the system retrieves contemporaneous information relevant to one or more of the contacts in the list including but not limited to relevant news headlines, stock prices, and/or important dates such as a birthday or the anniversary of the founding of a company. In several embodiments, the prioritization (urgency index) of the recommendations is determined by evaluating the relative importance of the groups the contact is associated with, the measured gap (either relationship gap for strategic relationship building or engagement gap if part of group that pertains to getting things done). Furthermore the user can filter the set of prioritized recommendations on the call sheet by any data or metadata present in the records of the user's contacts; for instance, the user can filter the set of prioritized recommendations by a specific geographic area in case the user will be in that area at a particular point in time. In other instances, any of a variety of filters can be utilized to prioritize a call sheet in accordance with embodiments of the invention.

In several embodiments, processes for generating a prioritized list of contact interaction recommendations involve scoring each contact with respect to a user's priorities. In a number of embodiments, contacts are scored with respect to one or more of a desired relationship objective, a group objective, and/or a goal. In many embodiments, the prioritized list is presented to the user interface as a list of actions to be taken within an initial period of time. FIG. 13A shows a time line view 140 of recommended actions. 144 is the area of the prioritized recommendations that are for today and 146 are recommendations for the future beyond today. The prioritized list can also include additional recommended actions to be performed over a subsequent period of time. In certain embodiments, processes for generating recommendations also look at due dates and/or deadlines associated with specific goals. In this way, the process can weigh both the importance of a recommended action in achieving a goal and the urgency with which the action should be completed in order to complete the goal prior to a defined deadline. In several embodiments, the user interface 140 also includes a mechanism 142 for adding additional items to the call sheet. As is discussed further below, the call sheet can be presented by a relationship management system and/or utilized to generate task entities that are displayed in a task list by a CRM system.

In a number of embodiments, a contact is scored based upon a user's priorities as follows:

score=n₁k₁a^{(1-m}^{₁}^{k}^{₁}⁾+n₂a^{(-m}^{₂}^{k}^{₂}⁾+n₃a^{(1-k}^{₃}^{R)}+n₄a^{(-k}^{₄}^{P)}+n₅(a^{(k}^{₅}^{G)}−1)
where k₁, k₂, k₃, k₄, and k₅ are weights;
   n₁, n₂, n₃, n₄, and n₅ are weights;
   m₁ is the number of minutes elapsed since the last event;
   m₂ is the number of minutes remaining until a reminder due date;
   R is the highest relevancy level;
   P is the highest priority level; and
   G is the relationship or engagement gap.

In several embodiments, the weights can be determined by observing the effects of interactions with contacts over time. In other embodiments, any of a variety of scoring functions can be utilized that weight any of a variety of factors including (but not limited to) different combinations of factors that weigh the time that has elapsed since the most recent interaction with a contract, time remaining to meet a deadline related to the contact, the relevancy of the contact, the extent to which interacting with a contact with advance a goal and/or the extent to which interacting with a contact can decrease the gap between a target relationship score or project engagement score for the contact and a current relationship or engagement score. Indeed contacts can be scored based upon user priorities using any of a variety of scoring processes appropriate to the requirements of specific applications. In a number of embodiments, users can select the factors that are included in the scoring function and/or modify the weightings applied to factors considered in the scoring function to account for specific user priorities and/or changes in user priorities. 143 shows how a user can query and reveal the logic of the relationship management system to reveal why a specific contact has been suggested for action. For example, a user may prioritize building relationships to a greater extent than achieving specified goals during a first period of time and then switch focus to more highly weight achieving specific goals during a second period of time.

A user interface for presenting a prioritized list of recommended user interactions with a user's contacts in accordance with an embodiment of the invention is illustrated in FIG. 13B. The user interface includes a prioritized call list in which recommended actions with respect to specific contacts are ranked according to priority. An initial set of prioritized actions and an additional list of actions are provided. In many instances, providing a limited number of urgent actions can focus a user's attention on specific tasks and increase the likelihood of the completion of one or more of the urgent actions. As can readily be appreciated, the prioritization of recommended actions can change dynamically in response to the aggregation of information by the relationship management system aggregating metadata indicating that the user has completed an action and/or performed a different action that alters the priority of previously recommended action (e.g. a user advances a goal by performing an action that has a similar outcome to a recommended action). In other embodiments, any of a variety of user interface mechanisms can be utilized to present a prioritized list of recommended user interactions with a user's contacts.

Although specific examples of analytics and recommendations are discussed above with respect to FIGS. 13A and 13B, any of a variety of analytic processes and recommendations can be performed by a relationship management system in accordance with embodiments of the invention based upon the data aggregated by the relationship management system and the scores generated by the scoring engine. In several embodiments, the recommendations are enhanced by conducting automated psychometric surveys of users to understand how each user best interacts with contacts. The information obtained from the survey can then be utilized by the relationship management system in selecting the types of events to recommend in order to most effectively achieve the user's stated priorities; accordingly, the recommendation may be both in priority order and include suggested optimal mode of engagement to best advance the objective. In many embodiments, the relationship management system is configured to provide recommendations that enable users to optimize their overall scored social graph and/or their scored social graph with respect to one or more objectives. In a number of embodiments, the optimization of the social graph can be formulated as a constrained optimization problem based upon the resources (such as time) a user has available to cultivate relationships within the user's social network. As a specific example, the user could query the system for what optimal action should be taken in the next hour.

### Indexing Metadata

Relationship management systems in accordance with embodiments of the invention can aggregate information concerning a contact from a variety of sources. In many embodiments, the information is indexed to enable the scoring of contacts with respect to relevance to a specific topic, keyword or search query. In this way, indexed metadata concerning contacts can be utilized to group contacts according to relevance to a specific topic or according to similarity. In many embodiments, indexed metadata concerning contacts can be searched to identify contacts relevant to a particular query. In several embodiments, the contacts returned in response to a specific query can be automatically utilized to populate a project group.

In a number of embodiments, a combination of structured data and indexed metadata can be utilized to search for contacts relevant to a specific query. For example, a natural language query such as “I am in New York for three days, who should I contact to discuss advertising strategy?” can be utilized to identify contacts within the relevant geographic location and that are relevant to the specified topic. In many embodiments, queries are parsed to identify relevant keywords and the keywords utilized to query the structured data and/or indexed metadata. Although specific examples are described above for indexing metadata and utilizing the indexed metadata. Any of a variety of techniques can be utilized for indexing metadata concerning contacts and events collected by relationship management systems and for identifying events and contacts relevant to specific queries in accordance with embodiments of the invention.

### Data Mining

In addition to performing analytics based upon an individual user's social graph, relationship management systems in accordance with embodiments of the invention can perform data mining across all or a subset of users that maintain accounts with the relationship management system. In several embodiments, each user's data is stored separately and the data mining process is performed across all sets of user data. In a number of embodiments, users' data are stored as part of a single many-to-many directional social graph (i.e. connections typically are not assumed to be two-way) and the data mining processes are simply applied to the overall scored social graph; this scored social graph could provide a visualized view of a group collective network and allow for recommendations on how to best connect between third parties using the highest scored (strongest) routing.

### Network Prospecting

Based upon analysis of overall user data, a relationship management system in accordance with embodiments of the invention is able to provide recommendations concerning the types of contacts that would be beneficial for a specific user based upon the user's description of themselves and specific objectives identified by the user. As with analytics and recommendations, the extent of the information that can be obtained through data mining processes in accordance with embodiments of the invention is typically only limited by the data aggregated by the relationship management system. In addition to making recommendations concerning the importance of contacts and relationship targets based upon a user's specified priorities, data mining can be performed to make recommendations concerning types of contacts from whom the user can obtain benefits that are not currently being prioritized by the user. In many embodiments, the relationship management system can identify affinity between users and compare the types of contacts that different users regard as important and with whom users have cultivated strong relationships. The effort expended in cultivating strong relationships is typically indicative of the user deriving significant benefits from the relationship. When a similar type of contact is present in a similar user's social network, then the relationship management system can make a recommendation that the user could benefit from strengthening the user's relationship with that contact. In a number of embodiments, data mining is used to provide a user with a broader template for the composition of a social network that is characteristic of someone successful within the user's field. Indeed, as is typically the case with data mining, the potential benefits that can be obtained through the analysis of the scored social graphs and aggregated event information maintained by a relationship management system is only limited by the nature of the information itself. A typical CRM does not provide relationship recommendations, but is limited to managing specific opportunities and tracking historical communication with contacts.

### Workgroups and Enterprises

Although much of the above discussion focuses on the interaction between a relationship management system and an individual user, a relationship management system in accordance with embodiments of the invention can be deployed across a workgroup or an enterprise to provide team benchmarking, and a tool to support collaborative networking or optimization of shard social networks for a group of users. For example, a team member can ascertain whether another team member has a sufficiently strong relationship with an individual to perform a desired action with respect to the individual (e.g. request a benefit or arrange a meeting that will strengthen both users' relationship with the contact). In addition, the relationship management system can provide an opportunity for an organization to monitor the progress of business development efforts that typically have not been quantifiable. In particular, CRM systems are good ways to show progress against names opportunities through selling stages to closed business, they are not effectively able to show real-time benchmarking of relationship building and deal engagement activities that are critical to driving deals to outcomes.

As described above, one or more objectives may be specified with respect to a customer entity (e.g., a company or other organization), an account entity (e.g., a company account) and/or an opportunity entity (e.g., a new business venture). Furthermore, one or more users (e.g., sales employees within a company) may be associated with an objective, and the users may each have individual duties with respect to achieving the particular objective. For example, in a multi-stage deal setting, different users may have different duties with respect to the overall objective. Likewise, one or more contacts (e.g., people needed/and or helpful in achieving the objective outside of the company users) may also be associated with the objective, and these contacts may be contacts of the users and/or potential contacts that may help achieve the objective. The scored social graph may provide engagement scores that benchmark the progress of the users towards achieving the particular objective. In some embodiments, the relationship management system may monitor the events (e.g., interactions and meetings) taking place between the users and the contacts in order to determine engagement scores with respect to an objective. For example, an objective of company A may be to land a new company B as a customer. The scored social graph may include a set of users needed to achieve the objective (e.g., a group of sales employees at company A). The scored social graph may also include a set of contacts to build relationships with in order to achieve the objective (e.g., management and executives at company B). The relationship management system may determine engagement scores with respect to achieving the objective (e.g., landing company B as a customer) based on the level of events between the set of users and the set of contacts. As described above, this scoring may take into account various factors, including the type of contact (e.g., title, position), the type of event (phone call, lunch meeting), the frequency of the event (e.g., how often people communicate), and the duration since the last event. Furthermore, the engagement scores may be computed based on the relationship scores of the users with the contacts. For example, as individual users strengthen relationships with contacts associated with an objective, the engagement scores may increase to indicate the progress towards achieving the objective. Thus the scored social graph may provide scores for both relationships between users and contacts and/or engagement scores relative to the progress towards an objective. Furthermore, as described above, an overall objective may be broken down into one or more different sub-stages, with each stage progressing towards reaching the overall objective. For example, achieving a deal may involve many sub-stages that need to be accomplished in order to move the deal forward, and each stage may involve a certain set of users communicated with a specific set of contacts. Thus, providing scoring at various sub-stages allows for better transparency and analysis of activities with respect to an overall objective. Although examples of scoring relationships and/or engagement towards objectives based on events between users and contacts is described above, scoring of relationships and objectives may be based on various other factors, including subjective information provided by users, machine learning techniques, among various others. Furthermore, in many embodiments, information may be obtained from a third party CRM system or other source, and the relationship management system may compute one or more scores based on the information, and provide the scores back to the third party CRM system.

Integration with Online Social Networks

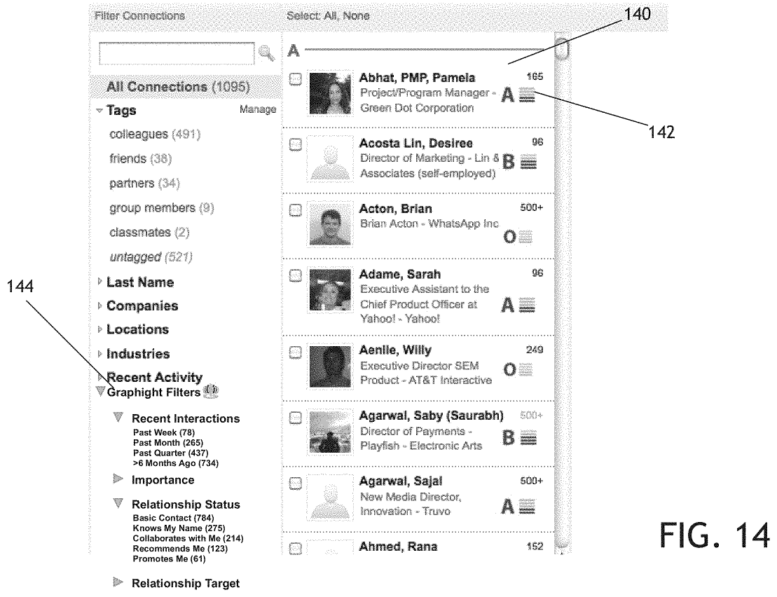

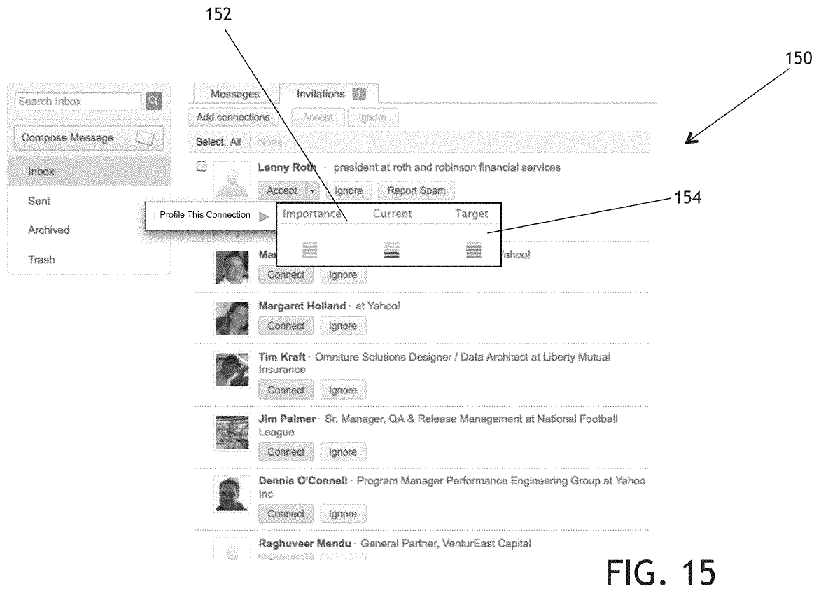

As discussed above, relationship management systems in accordance with embodiments of the invention can provide an API and/or utilize the API of online social networks to provide integration between the relationship management system and the online social network. In a number of embodiments, relationship scores generated by the relationship management system can be provided to the online social network for display within the online social network. A conceptual illustration of the integration of relationship scores within a social networking service is illustrated in FIG. 14. In the illustrated embodiment, a user's contacts 140 within the social networking service are displayed and a relationship score 142 generated by a relationship management system in accordance with embodiments of the invention is integrated into the user interface. In a number of embodiments, the relationship scores are provided via an API to the social network servers for display via the user interface. In the illustrated embodiment, the relationship score includes a priority designation and an indication of the strength of the relationship. In other embodiments, any of a variety of relationship score metrics can be presented in any of a variety of different ways. In several embodiments, the relationship management system can also provide filters 144 that enable the online social network to filter contacts based upon information collected by the relationship management service. In addition to providing information to an online social network, integration with an online social network can be utilized by a relationship management system to obtain information that can be utilized in the generation of a scored social graph and/or the generation of recommendations. A conceptual illustration of the integration of a user interface with a social networking service that can be utilized by a user to characterize relationships defined within the online social network for use by a relationship management system in accordance with an embodiment of the invention is illustrated in FIG. 15. The user interface 150 includes mechanisms 152 for characterizing the relationship the user has with a contact and a relationship target 154 for the relationship. In the illustrated embodiment, the mechanism is a thermometer input for each of the relationship's importance, current relationship score and target relationship score. Although integration with a specific online social network and specific forms of integration are illustrated in FIGS. 14 and 15, relationship management systems can be integrated with any of a variety of online social networks and the integration can support any of a variety of features designed to provide and/or gather information in accordance with embodiments of the invention.

Integration with CRM Systems

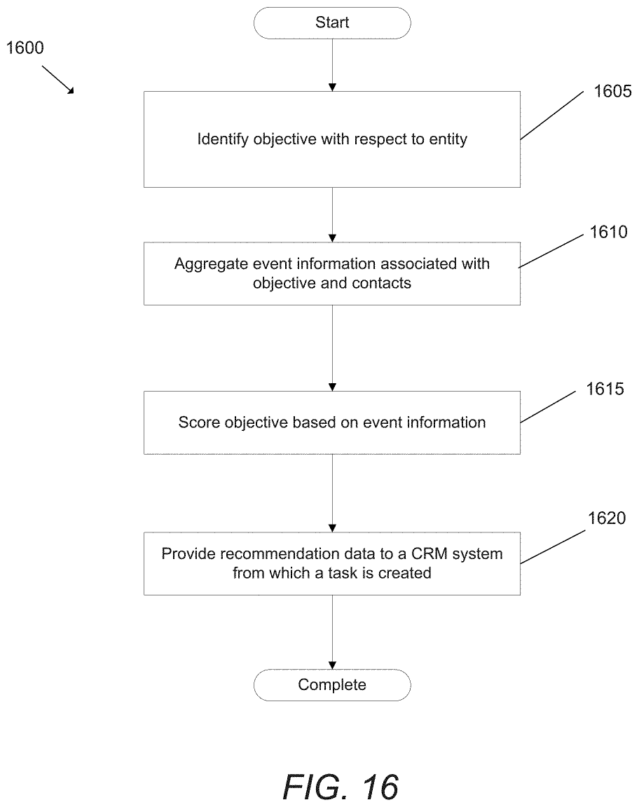

As described above, in many embodiments, the relationship management system aggregates event information from a CRM system, generates scores, and provides recommendations back to the CRM system from which task lists may be generated. An example of a process for communicating with a CRM system for generating task lists in accordance with an embodiment of the invention is illustrated in FIG. 16. The process 1600 identifies (at 1605) an objective with respect to an entity. In some embodiments the entity may be defined by a third-party CRM system.

The process aggregates (at 1610) event information associated with the objective and a set of contacts from at least one source of information. In several embodiments, the source of information may be a CRM system.

The process scores (at 1615) the objective based upon event information associated with the set of contacts to generate at least one engagement score.

The process provides (at 1620) recommendation data to the CRM system from which a task is created within the CRM system associated with at least one contact in the set of contacts based on the at least one engagement score. The process completes. Although a specific process for aggregating event information from a CRM system and providing recommendation data to the CRM system based on the event information is illustrated in FIG. 16, any of a variety of processes can be used to provide recommendation data to a CRM system based on event information in accordance with embodiments of the invention.

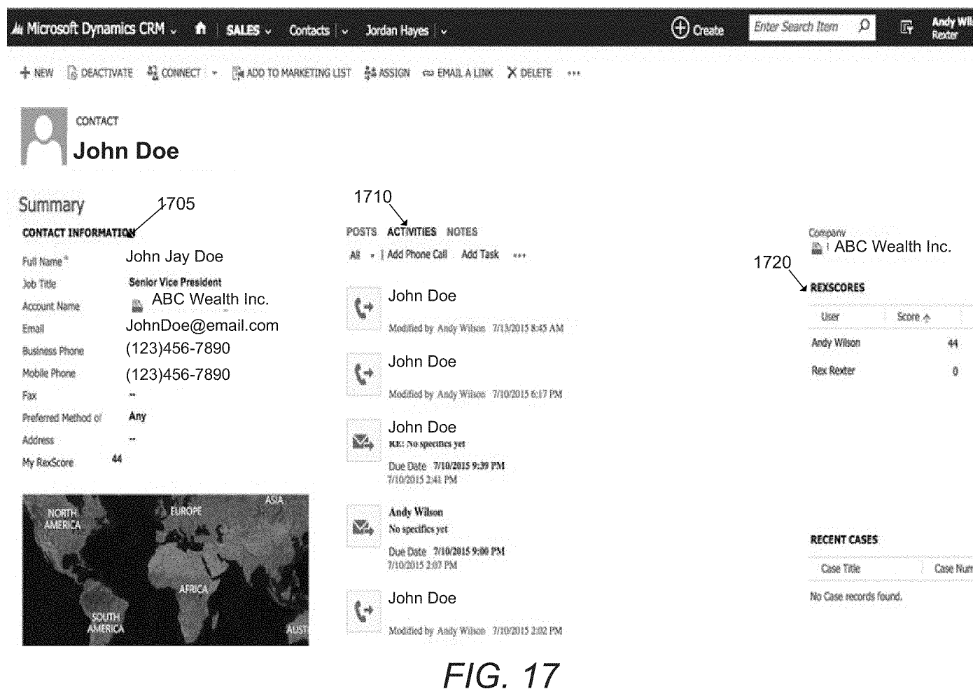

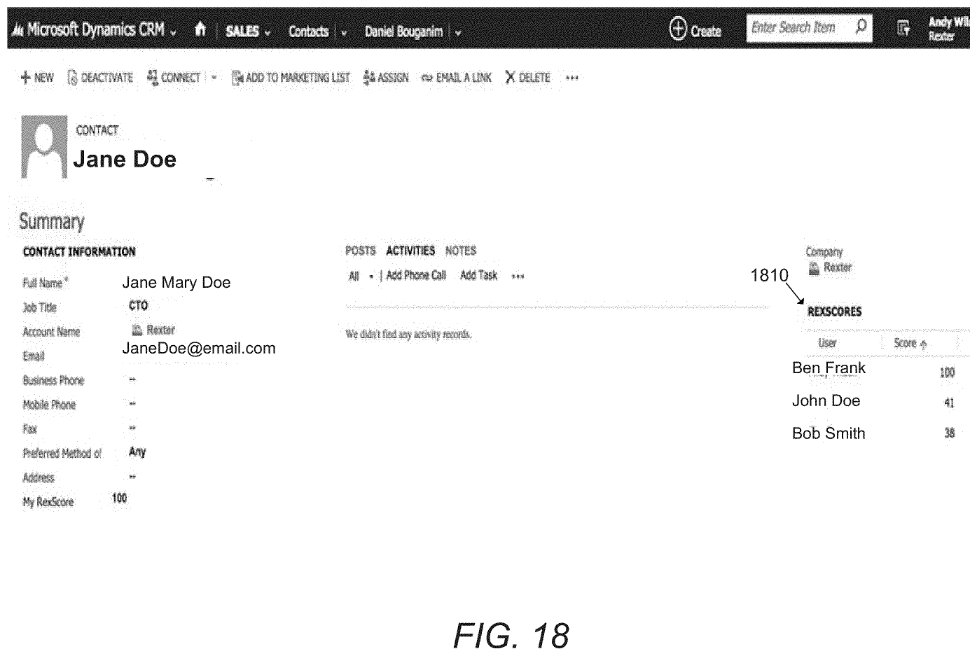

Examples of user interfaces of a CRM system that incorporates data obtained from a relationship management system in accordance with many embodiments of the invention are illustrated in FIG. 17-18.

FIG. 17 illustrates a user interface of a CRM system that is integrated with a relationship management system in accordance with an embodiment of the invention. As illustrated, the UI displays information 1705 for a particular contact (e.g., John Doe), that is stored within the CRM system. The contact information includes a variety of information, including the contact name, title, emails, phone numbers. Furthermore, the UI displays a set of activities 1710. As described above, in some embodiments, these activities may be generated based on event information automatically captured and provided by a relationship management system. In some embodiments, the relationship management system may aggregate event information from a plurality of different sources of event information. In several embodiments, the CRM system may also aggregate event information, which could supplement information aggregated by the relationship management system.

The UI also displays several “Rexscores”, which are relationship scores of the user, John Doe, with other contacts (e.g., Andy Wilson score 44, and Rex Rexter score 0).

FIG. 18 illustrates another example of a user interface of a CRM system that is integrated with a relationship management system in accordance with an embodiment of the invention. This example illustrates the contact information for the contact, Jane Doe. As illustrated, the UI provides various relationship scores, displayed as “Rexscores” 1810, for a particular user, which includes: Ben Frank score 100, John Doe score 41, and Bob Smith score 38. Thus, based on this information, a user would be able to quickly know that this contact has the strongest relationship with Ben Frank and the weakest relationship with Bob Smith, and accordingly, the user may prioritize their activities while taking into consideration this information.

Although example CRM user interfaces are illustrated in FIGS. 17 and 18, any of a variety of interfaces and/or CRM systems may utilize recommendation data in a variety of different mechanisms as appropriate to the requirements of specific applications in accordance with embodiments of the invention.

### Renewal Recommendations

As described above, in a number of embodiments, the relationship management system is configured to monitor entities within a CRM system having renewal deadlines and uses relationship scores for contacts associated with the renewing entities to add tasks related to increasing relationship scores with contacts at the renewing entity to a CRM system in advance of the renewing deadline. For example, a user may have a client that renews a contract on a yearly basis. In order to help increase the likely hood that the client is willing to renew the contract, prior to the renewal date, it may be good business practice for the user to reach out to the client to increase the strength of the relationship with the contact. However, balancing the effort required to maintain existing relationships while also generating new clients and establishing new relationships requires a limited amount of time and/or resources of the user. Thus, in many embodiments, the relationship management system may generate task entities to provide to a CRM system with tasks that a user may consider to strengthen a relationship to increase the likelihood that a renewal will be obtained. In certain embodiments, the tasks may be generated only for contacts whose relationship scores are below a threshold such that it is possible that the contact may not renew a contract. In these situations, for example, it would be beneficial for a user to take certain actions with respect to the contact to help increase the likelihood that the contact will renew their contract.

In several embodiments, the relationship management system may identify contacts based on relationship scores that are now sufficiently robust such that the contacts may be good candidates for achieving a particular objective. For example, in a sales CRM system, the relationship management system may score relationships that a user has with various contacts. Once a relationship score satisfies a certain threshold, the contact may be a good candidate for contacting with respect to a sales offer. In certain embodiments, machine learning techniques may be utilized to analyze data of contacts with which objectives have been successfully achieved, and based on this analysis, this relationship management system may provide recommendations and/or tasks for other contacts in order to achieve similar objectives. For example, if a certain level of event activity between a user and a contact has been achieved prior to a deal being reached in a majority of prior deals, then the relationship management system may use this historic information to determine when a current deal in progress and/or a future deal obtains the same requisite level of event activity to increase the likelihood of success of the deal. In many embodiments, the relationship management system may generate task entities to provide to a CRM system that may be displayed within a task list by the CRM system.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A relationship management system, comprising:
a relationship management server system comprising a processor and memory containing software; and
a database storing a plurality of contacts, wherein the plurality of contacts are obtained from at least one source of contact information;
wherein the software directs the processor in the relationship management server system to:
identify an objective with respect to an entity defined by a customer relationship management (CRM) service;
identify a first set of contacts within the plurality of contacts associated with the objective;
aggregate event information associated with the first set of contacts from at least one source of event information;
score the objective based upon event information associated with the first set of contacts to generate at least one engagement score; and
provide recommendation data to the CRM service from which a task is created within the CRM service associated with at least one contact in the first set of contacts based upon the at least one engagement score.

2. The relationship management system of claim 1, wherein the software directs the processor in the relationship management server system to identify additional contacts that are stored within the CRM service that are not in the plurality of contacts stored in the database and update the plurality of contacts to include the additional contacts.

3. The relationship management system of claim 1, wherein at least one source of contact information is selected from the group consisting of a CRM service, a web mail service, an enterprise mail system, and an online social network.

4. The relationship management system of claim 1, wherein the software directs the processor in the relationship management server system to aggregate event information from at least one source of event information selected from the group consisting of a CRM service, a web mail service, an enterprise mail system, a web calendaring service, an enterprise calendaring system, call data records, and an online social network.

5. The relationship management system of claim 1, wherein the software directs the processor in the relationship management server system to score at least one relationship between contacts in the first set of contacts based upon the aggregated event information to create a scored relationship graph.

6. The relationship management system of claim 5, wherein the at least one stored objective relates to a specific project entity within a database maintained by a CRM service.

7. The relationship management system of claim 6, wherein the at least one stored objective relates to the scored relationship graph.

8. The relationship management system of claim 5, wherein the software directs the processor in the relationship management system to recommend at least one new contact for inclusion in the first set of contacts based on aggregated event information.

9. The relationship management system of claim 5, wherein the software directs the processor in the relationship management server system to provide data regarding the relationship scores between a user and a contact to the CRM service for display within a user interface (UI) generated by the CRM service.

10. The relationship management system of claim 5, wherein the software directs the processor in the relationship management system to aggregate event information based on metadata obtained from the at least one source of event information, wherein the metadata comprises information selected from the group consisting of entities related to an event, a type of event, a duration of the event, and an intimacy level of the event.

11. The relationship management system of claim 5, wherein the event information comprises information regarding offline interactions between users and contacts comprising phone calls, transactions, collaborative projects, and in-person meetings.

12. The relationship management system of claim 5, wherein the event information comprises information regarding online communications between users and contacts comprising electronic communications.

13. The relationship management system of claim 5, wherein a relationship score provides an indication of a strength of a relationship between a user and a contact.

14. The relationship management system of claim 5, wherein the software directs the processor in the relationship management system to:
analyze the scored relationship graph to identify at least one contact for inclusion in the first set of contacts based on a relationship score of the contact; and
associate the identified at least one contact for inclusion in the first set of contacts with the objective.

15. The relationship management system of claim 13, wherein the software directs the processor in the relationship management system to:
analyze the scored relationship graph to identify at least one contact with a relationship score below a threshold value;
generate a recommendation with respect to the identified contact in order to increase the relationship score.

16. The relationship management system of claim 1, wherein the at least one engagement score provides an indication of progress of a group of users relative to an objective.

17. The relationship management system of claim 1, wherein an entity is selected from the group consisting of a customer entity, an account entity, and an opportunity entity.

18. The relationship management system of claim 1, wherein an objective is defined by associating contacts with the objective.

19. The relationship management system of claim 1, wherein the software directs the processor in the relationship management system to provide prioritized recommendations concerning the most important actions to take to achieve an objective.

20. The relationship management system of claim 1, wherein the software directs the processor in the relationship management system to generate a call sheet comprising at least one recommendation concerning an action relevant to achieving the objective.
